(19) United States
(12) Patent Application Publication
(10) Pub. No.: US 2025/0279810 A1
(43) Pub. Date: Sep. 4, 2025

(54) SYSTEMS AND METHODS FOR RADIO FREQUENCY CALIBRATION EXPLOITING CHANNELRECIPROCITY IN DISTRIBUTED INPUT DISTRIBUTED OUTPUT WIRELESS COMMUNICATIONS

(71) Applicant: Rearden, LLC, Palo Alto, CA (US)

(72) Inventors: Antonio Forenza, San Francisco, CA (US); Fadi Saibi, Sunnyvale, CA (US); Timothy A. Pitman, San Francisco, CA (US); Stephen G. Perlman, Palo Alto, CA (US)

(21) Appl. No.: 19/199,110

(22) Filed: May 5, 2025

Related U.S. Application Data
(63) Continuation of application No. 18/921,858, filed on Oct. 21, 2024, now Pat. No. 12,355,520.
Application No. 18/921,858 is a continuation of application No. 18/109,207, filed on Feb. 13, 2023, now Pat. No. 12,166,546.
Application No. 18/109,207 is a continuation of application No. 17/498,666, filed on Oct. 11, 2021, now Pat. No. 11,581,924.
Application No. 17/498,666 is a continuation of application No. 16/719,169, filed on Dec. 18, 2019, now Pat. No. 11,146,313.
Application No. 16/719,169 is a continuation of application No. 13/844,355, filed on Mar. 15, 2013, now Pat. No. 10,547,358.

(51) Int. Cl. H04B 7/0452; H04B 7/024; H04B 7/0456; H04B 7/06; H04B 17/12; H04L 25/02

(52) U.S. Cl. CPC H04B 7/0452; H04B 7/024; H04B 7/0456; H04B 7/0626; H04B 17/12; H04L 25/0224

(57) ABSTRACT

Systems and methods are described for radio frequency (RF) calibration in a multiple antenna system (MAS) with multi-user (MU) transmissions (“MU-MAS”) exploiting uplink/downlink channel reciprocity. The RF calibration is used to compute open-loop downlink precoder based on uplink channel estimates, thereby avoiding feedback overhead for channel state information as in closed-loop schemes. For example, a MU-MAS of one embodiment comprises a wireless cellular network with one or multiple beacon stations, multiple client devices and multiple distributed antennas operating cooperatively via precoding methods to eliminate inter-client interference and increase network capacity.

### CROSS REFERENCE TO RELATED APPLICATION

This application is a continuation of co-pending U.S. patent application Ser. No. 18/921,858, filed Oct. 21, 2024, which is a continuation of U.S. patent application Ser. No. 18/109,207, now U.S. issued U.S. Pat. No. 12,166,546, issued on Dec. 10, 2024, which is a continuation of U.S. patent application Ser. No. 17/498,666, filed Oct. 11, 2021, now U.S. issued U.S. Pat. No. 11,581,924, issued on Feb. 14, 2023, which is a continuation of U.S. patent application Ser. No. 16/719,169, filed on Dec. 18, 2019, now U.S. issued U.S. Pat. No. 11,146,313, issued on Oct. 12, 2021, which is a continuation of U.S. patent application Ser. No. 13/844,355, which was filed Mar. 15, 2013, now U.S. issued U.S. Pat. No. 10,547,358, issued on Jan. 28, 2020, all of which is herein incorporated by reference.

### RELATED APPLICATIONS

This application may be related to the following U.S. Patents (“Related Patents and Applications”):

U.S. Pat. No. 10,886,979, issued Jan. 4, 2021, entitled “System And Method For Link adaptation In DIDO Multicarrier Systems”

U.S. Pat. No. 10,425,134, issued Sep. 24, 2019, entitled “System and Methods for planned evolution and obsolescence of multiuser spectrum”

U.S. Pat. No. 10,277,290, issued Apr. 30, 2019, entitled “Systems and Methods to Exploit Areas of Coherence in Wireless Systems”

U.S. Pat. No. 10,200,094, issued Feb. 5, 2019, entitled “Interference Management, Handoff, Power Control And Link Adaptation In Distributed-Input Distributed-Output (DIDO) Communication Systems”

U.S. Pat. No. 10,187,133, issued Jan. 22, 2019, entitled “System And Method For Power Control And Antenna Grouping In A Distributed-Input-Distributed-Output (DIDO) Network”

U.S. Pat. No. 10,164,698, issued Dec. 25, 2018, entitled “Systems and Methods for exploiting inter-cell multiplexing gain in wireless systems via distributed input distributed output technology”

U.S. Pat. No. 9,973,246, issued May 15, 2018, entitled “Systems and Methods for exploiting inter-cell multiplexing gain in wireless systems via distributed input distributed output technology”

U.S. Pat. No. 9,923,657, issued Mar. 20, 2018, entitled “Systems and Methods for exploiting inter-cell multiplexing gain in wireless systems via distributed input distributed output technology”

U.S. Pat. No. 9,826,537, issued Nov. 21, 2017, entitled “System And Method For Managing Inter-Cluster Handoff Of Clients Which Traverse Multiple DIDO Clusters”

U.S. Pat. No. 9,819,403, issued Nov. 14, 2017, entitled “System And Method For Managing Handoff Of A Client Between Different Distributed-Input-Distributed-Output (DIDO) Networks Based On Detected Velocity Of The Client”

U.S. Pat. No. 9,685,997, issued Jun. 20, 2017, entitled “Systems and Methods to enhance spatial diversity in distributed-input distributed-output wireless systems”

U.S. Pat. No. 9,312,929, issued Apr. 12, 2016, entitled “System and Methods to Compensate for Doppler Effects in Distributed-Input Distributed Output Systems”

U.S. Pat. No. 8,989,155, issued Mar. 24, 2015, entitled “Systems and Methods for wireless backhaul in distributed-input distributed-output wireless systems”

U.S. Pat. No. 8,654,815, issued Feb. 18, 2014, entitled “System and Method For Distributed Antenna Wireless Communications”

U.S. Pat. No. 8,571,086, issued Oct. 29, 2013, entitled “System And Method For DIDO Precoding Interpolation In Multicarrier Systems”

U.S. Pat. No. 8,542,763, issued Sep. 24, 2013, entitled “Systems And Methods To Coordinate Transmissions In Distributed Wireless Systems Via User Clustering”

U.S. Pat. No. 8,170,081, issued May 1, 2012, entitled “System And Method For Adjusting DIDO Interference Cancellation Based On Signal Strength Measurements”

U.S. Pat. No. 8,160,121, issued Apr. 17, 2012, entitled, “System and Method For Distributed Input-Distributed Output Wireless Communications”,

U.S. Pat. No. 7,885,354, issued Feb. 8, 2011, entitled “System and Method For Enhancing Near Vertical Incidence Skywave (“NVIS”) Communication Using Space-Time Coding.”

U.S. Pat. No. 7,711,030, issued May 4, 2010, entitled “System and Method For Spatial-Multiplexed Tropospheric Scatter Communications”;

U.S. Pat. No. 7,636,381, issued Dec. 22, 2009, entitled “System and Method for Distributed Input Distributed Output Wireless Communication”;

U.S. Pat. No. 7,633,994, issued Dec. 15, 2009, entitled “System and Method for Distributed Input Distributed Output Wireless Communication”;

U.S. Pat. No. 7,599,420, issued Oct. 6, 2009, entitled “System and Method for Distributed Input Distributed Output Wireless Communication”;

U.S. Pat. No. 7,418,053, issued Aug. 26, 2008, entitled “System and Method for Distributed Input Distributed Output Wireless Communication”;

### BACKGROUND

In the last three decades, the wireless cellular market has experienced increasing number of subscribers worldwide as well as demand for better services shifting from voice to web-browsing and real-time HD video streaming. This increasing demand for services that requires higher data rate, lower latency and improved reliability has driven a radical evolution of wireless technologies through different standards. Beginning from the first generation analog AMPS and TACS (for voice service) in the early 1980s, to 2G and 2.5G digital GSM, IS-95 and GPRS (for voice and data services) in the 1990s, to 3G with UMTS and CDMA2000 (for web-browsing) in the early 2000s, and finally LTE (for high-speed internet connectivity) currently under deployment in different countries worldwide.

Long-term evolution (LTE) is the standard developed by the 3^{rd} generation partnership project (3GPP) for fourth generation (4G) wireless cellular systems. LTE can achieve theoretically up to 4× improvement in downlink spectral efficiency over previous 3G and HSPA+ standards by exploiting the spatial components of wireless channels via multiple-input multiple-output (MIMO) technology. LTE-Advanced is the evolution of LTE, currently under standardization, that will enable theoretically up to 8× increase in spectral efficiency over 3G standard systems.

Despite this technology evolution, it is very likely that in the next three years wireless carriers will not be able to satisfy the growing demand for data rate due to raising market penetration of smartphones and tables, offering more data-hungry applications like real-time HD video streaming, video conferencing and gaming. It has been estimated that capacity of wireless networks will grow 5× in Europe from 2011 to 2015 due to improved technologies such as LTE as well as more spectrum made available by the government [Reference 25]. For example, the FCC is planning to free 500 MHz of spectrum by 2020 (of which 300 MHz will be available by 2015) to promote wireless Internet connectivity throughout the US as part of the National Broadband Plan [Reference 24]. Unfortunately, the forecast for capacity usage by 2015 is 23× over 2011 in Europe [Reference 25] and similar spectrum deficit is expected to happen in the US by 2014 [References 26-27]. As a result of this data crunch, revenues for wireless carriers may drop below their CAPEX and OPEX with potentially devastating impact on the wireless market [Reference 28].

As capacity gains offered by LTE deployment and increased spectrum availability are insufficient, the only foreseeable solution to prevent this upcoming spectrum crisis is to promote new wireless technologies [Reference 29]. LTE-Advanced (the evolution of LTE standard) promises additional gains over LTE through more sophisticated MIMO techniques and by increasing the density of “small cells” [Reference 30]. However, there are limits to the number of cells that can fit a certain area without incurring interference issues or increasing the complexity of the backhaul to allow coordination across cells.

One promising technology that will provide orders of magnitude increase in spectral efficiency over wireless links without the limitations of conventional cellular systems is distributed-input distributed-output (DIDO) technology (see Related Patents and Applications above. The present invention describes DIDO technology employed in the context of cellular systems (such as LTE or LTE-Advanced), both within and without the constraints of cellular standards, to provide significant performance benefits over conventional wireless systems. We begin with an overview on MIMO and review different spatial processing techniques employed by LTE and LTE-Advanced. Then we show how the present invention provides significant capacity gains for next generation wireless communications systems compared to prior art approaches.

MIMO employs multiple antennas at the transmitter and receiver sides of the wireless link and uses spatial processing to improve link reliability via diversity techniques (i.e., diversity gain) or provide higher data rate via multiplexing schemes (i.e., multiplexing gain) [References 1-2]. Diversity gain is a measure of enhanced robustness to signal fading, resulting in higher signal-to-noise ratio (SNR) for fixed data rate. Multiplexing gain is obtained by exploiting additional spatial degrees of freedom of the wireless channel to increase data rate for fixed probability of error. Fundamental tradeoffs between diversity and multiplexing in MIMO systems were described in [References 3-4].

In practical MIMO systems, link adaptation techniques can be used to switch dynamically between diversity and multiplexing schemes based on propagation conditions [20-23]. For example, link adaptation schemes described in [References 22-23] showed that beamforming or Orthogonal Space-Time Block Codes (OSTBC) are preferred schemes in low SNR regime or channels characterized by low spatial selectivity.

By contrast, spatial multiplexing can provide significant gain in data rate for channels with high SNR and high spatial selectivity. For example, FIG. 1 shows that cells can be divided in two regions: i) multiplexing region 101, characterized by high SNR (due to proximity to the cell tower or base station) where the spatial degrees of freedom of the channel can be exploited via spatial multiplexing to increase data rate; ii) diversity region 102 or cell-edge, where spatial multiplexing techniques are not as effective and diversity methods can be used to improve SNR and coverage (yielding only marginal increase in data rate). Note that the circle of the macrocell 103 in FIG. 1 labels the shaded center of the circle as the “multiplexing region” and the unshaded outer region of the circle as the “diversity region”. This same region designation is used throughout FIGS. 1,3-5, where the shaded region is the “multiplexing region” and the unshaded region is the “diversity region”, even if they are not labeled. For example, the same designation is used for the small-cell 104 in FIG. 1.

The LTE (Release 8) and LTE-Advanced (Release 10) standards define a set of ten transmission modes (TM) including either diversity or multiplexing schemes [References 35,85-86]:
Mode 1: Single antenna port, port 0
Mode 2: Transmit diversity
Mode 3: Large-delay cyclic delay diversity (CDD), extension of open-loop spatial multiplexing for single-user MIMO (SU-MIMO)
Mode 4: Closed-loop spatial multiplexing for SU-MIMO
Mode 5: Multi-user MIMO (MU-MIMO)
Mode 6: Closed-loop spatial multiplexing, using a single transmission layer
Mode 7: Single antenna port, UE-specific RS (port 5)
Mode 8: Single or dual-layer transmission with UE-specific RS (ports 7 and/or 8)
Mode 9: Single or up to eight layers closed-loop SU-MIMO (added in Release 10)
Mode 10: Multi-layer closed-loop SU-MIMO, up to eight layers (added in Release 10)

Hereafter we describe diversity and multiplexing schemes commonly used in cellular systems as well as specific methods employed in LTE as outlined above, and compare them against techniques that are unique for DIDO communications. We first identify two types of transmission methods: i) intra-cell methods (exploiting micro-diversity in cellular systems), using multiple antennas to improve link reliability or data rate within one cell; ii) inter-cell methods (exploiting macro-diversity), allowing cooperation between cells to provide additional diversity or multiplexing gains. Then we describe how the present invention provides significant advantages (including spectral capacity gain) over prior art.

### 1. Intra-cell Diversity Methods

Intra-cell diversity methods operate within one cell and are designed to increase SNR in scenarios with poor link quality (e.g., users at the cell-edge subject to high pathloss from the central tower or base station). Typical diversity schemes employed in MIMO communications are beamforming [References 5-11] and orthogonal space-time block codes (OSTBC) [References 12-15].

Diversity techniques supported by the LTE standard are transmit diversity, closed-loop rank-1 precoding and dedicated beamforming [References 31-35]. Transmit diversity scheme supports two or four transmit antennas over the downlink (DL) and only two antennas for the uplink (UL). In the DL channel, it is implemented via space-frequency block codes (SFBC) combined with frequency-switched transmit diversity (FSTD) to exploit space as well as frequency selectivity Reference [31]. Rank-1 precoding creates a dedicated beam to one user based on quantized weights selected from a codebook (pre-designed using limited feedback techniques [References 36-42]) to reduce the feedback overhead from the user equipment (UE) to the base transceiver station (BTS 105 in FIG. 1, or eNodeB using LTE terminology). Alternatively, dedicated beamforming weights can be computed based on UE-specific reference signal. 2. Intra-cell Multiplexing Methods

MIMO multiplexing schemes [References 1,19] provide gain in data rate in high SNR regime and in scenarios with enough spatial degrees of freedom in the channel (e.g., rich multipath environments with high spatial selectivity [References 16-18]) to support multiple parallel data streams over wireless links.

The LTE standard supports different multiplexing techniques for single-user MIMO (SU-MIMO) and multi-user MIMO (MU-MIMO) [Reference 31]. SU-MIMO schemes have two modes of operation: i) closed-loop, exploiting feedback information from the UE to select the DL precoding weights; ii) open-loop, used when feedback from the UE is unavailable or the UE is moving too fast to support closed-loop schemes. Closed-loop schemes use a set of pre-computed weights selected from a codebook. These weights can support two or four transmit antennas as well as one to four parallel data streams (identified by number of layers of the precoding matrix), depending on the UE request and decision of the scheduler at the BTS. LTE-Advanced will include new transmission modes up to MIMO 8×8 to provide up to 8× increase in spectral efficiency via spatial processing [Reference 62].

MU-MIMO schemes are defined for both UL and DL channels [References 31,50]. In the UL, every UE sends a reference signal to the BTS (consisting of cyclically shifted version of the Zadoff-Chu sequence [Reference 33]). Those reference signals are orthogonal, such that the BTS can estimate the channel from all UEs and demodulate data streams from multiple UEs simultaneously via spatial processing. In the DL, precoding weights for different UEs are selected from codebooks based on the feedback from the UEs and the scheduler (similarly to closed-loop SU-MIMO schemes) and only rank-1 precoding is allowed for every UE (e.g., each UE receives only one data stream).

Intra-cell multiplexing techniques employing spatial processing provide satisfactory performance only in propagation scenarios characterized by high SNR (or SINR) and high spatial selectivity (multipath-rich environments). For conventional macrocells, these conditions may be harder to achieve as BTSs are typically far from the UEs and the distribution of the SINR is typically centered at low values [Reference 43]. In these scenarios, MU-MIMO schemes or diversity techniques may be better choices than SU-MIMO with spatial multiplexing.

Other techniques and network solutions contemplated by LTE-Advanced to achieve additional multiplexing gain (without requiring spatial processing through MIMO) are: carrier aggregation (CA) and small cells. CA [References 30,44-47] combines different portions of the RF spectrum to increase signal bandwidth up to 100 MHz [Reference 85], thereby yielding higher data rates. Intra-band CA combines different bands within the same portion of the spectrum. As such it can use the same RF chain for multiple channels, and multiple data streams are recombined in software. Inter-band CA requires different RF chains to operate at different portions of the spectrum as well as signal processing to recombine multiple data streams from different bands.

The key idea of small cells [References 30,47] is to reduce the size of conventional macro-cells, thereby allowing higher cell density and larger throughput per area of coverage. Small-cells are typically deployed through inexpensive access points 106 with low power transmission (as depicted in FIG. 1) as opposed to tall and expensive cell towers used for macro-cells. Two types of small cells are defined in LTE-Advanced: i) metrocells, for outdoor installation in urban areas, supporting up 32 to 64 simultaneous users; and ii) femtocells, for indoor use, can serve at most 4 active users. One advantage of small cells is that the density of UEs close to the BTS is statistically higher, yielding better SNR that can be exploited via spatial multiplexing to increase data rate. There are, however, still many concerns about practical deployment of small cells, particularly related to the backhaul. In fact, it may be challenging to reach BTSs of every small cell via high-speed wireline connections, especially considering the high density of metrocells and femtocells in a given coverage area. While using Line-Of-Sight (LOS) backhaul to small cells can often be implemented inexpensively, compared to wireline backhaul, there often are no practical LOS backhaul paths available for preferred small cell BTS placements, and there is no general solution for Non-Line-Of-Sight (NLOS) wireless backhaul to small cell BTSs. Moreover, small cells require complex real-time coordination across BTSs to avoid interference as in self-organized networks (SON) [References 30,51-52] and sophisticated cell-planning tools (even more complex than conventional cellular systems, due to higher density of small cells) to plan their optimal location [References 48,49]. Finally, handoff is a limiting factor for small cells deployment, particularly in scenarios where groups of subscribers switch cells at the same time, causing large amount of handoff overhead over the backhaul, resulting in high latency and unavoidable dropped calls.

It can be trivially shown there is no practical general solution that enables small cells to co-exist with macrocells and achieve optimal, or necessarily even improved, throughput. Among the myriad of such unsolvable situations is when a small cell is located such that its UEs unavoidably overlap with a macrocell transmission and the small cell and the macrocell use the same frequencies to reach their respective UEs. Clearly in this situation, the macrocell transmission will interfere with the small cell transmission. While there may be some approach that mitigates such interference for particular circumstances of a particular macrocell, a particular small cell, the particular macrocell and small cell UEs involved, the throughput requirements of those UEs, and environmental circumstances, etc., any such approach would be highly specific, not only to the static plan of the macrocell and small cell, but to the dynamic circumstances of a particular time interval. Typically, the full throughput of the channel to each UE cannot be achieved.

### 3. Inter-cell Diversity Methods

In a heterogeneous network (HetNet) [Reference 90] where macro-cells coexist with small-cells (e.g., metro-cells, pico-cells and femto-cells) it is necessary to employ different techniques to eliminate inter-cell interference. While HetNets provide better coverage through small-cells, the gains in data rate are only marginal since they require sharing the spectrum through different forms of frequency reuse patterns or using spatial processing to remove interference rather than achieve multiplexing gain. The LTE standards employ inter-cell interference coordination (ICIC) schemes to remove interference particularly at the cell-edge. There are two types of ICIC methods: cell-autonomous and coordinated between BTSs.

Cell-autonomous ICIC schemes avoid inter-cell interference via different frequency reuse patterns depicted in FIG. 2, where the hexagons represent the cells and the colors refer to different carrier frequencies. Three types of schemes are considered in LTE: i) full frequency reuse (or reuse 1), where the cells utilize all the available bandwidth as in FIG. 2a, thereby producing high interference at the cell-edge; ii) hard frequency reuse (HFR), where every cell is assigned with a different frequency band as in FIG. 2b (with typical reuse factor of 3) to avoid interference across adjacent cells; iii) fractional frequency reuse (FFR), where the center of the cell is assigned with the whole available bandwidth as in frequency reuse 1, whereas the cell-edge operates in HFR mode to mitigate inter-cell interference as in FIG. 2c.

Coordinated ICIC methods enable cooperation across BTSs to improve performance of wireless networks. These techniques are a special case of methods taught in Related Patents and Applications above to enable cooperation across wireless transceivers in the general case of distributed antenna networks for multiple UEs all using the same frequency simultaneously. Cooperation across BTSs to remove inter-cell interference for the particular case of cellular systems for a single UE at a given time at a given frequency was described in [Reference 53]. The system in [Reference 53] divides every macrocell into multiple subcells and enables soft-handoff across subcells by employing dedicated beamforming from coordinated BTSs to improve link robustness at a single UE at a single frequency, as it moves along the subcell boundaries.

More recently, this class of cooperative wireless cellular networks has been defined in the MIMO literature as “network MIMO” or “coordinated multi-point” (CoMP) systems. Theoretical analysis and simulated results on the benefits obtained in network MIMO by eliminating inter-cell interference are presented in [References 54-61]. The key advantage of network MIMO and CoMP is to remove inter-cell interference in the overlapping regions of the cells denoted as “interference region” 301 in FIG. 3 for the case of macro-cells 302.

CoMP networks are actively becoming part of LTE-Advanced standard as a solution to mitigate inter-cell interference in next generation cellular networks [References 62-64]. Three CoMP solutions have been proposed so far in the standard to remove inter-cell interference: i) coordinated scheduling/beamforming (CS/CB), where the UE receives its data stream from only one BTS via beamfoming and coordination across BTSs is enabled to remove interference via beamforming or scheduling techniques; ii) dynamic cell selection (DCS) that chooses dynamically the cell for every UE on a per-subframe basis, transparently to the UE; iii) joint transmission (JT), where data for given UE is jointly transmitted from multiple BTSs to improve received signal quality and eliminate inter-cell interference. CoMP-JT yields larger gains than CoMP-CS/CB at the expenses of higher overhead in the backhaul to enable coordination across BTSs.

### 4. Inter-cell Multiplexing Methods

Prior art multi-user wireless systems add complexity and introduce limitations to wireless networks which result in a situation where a given user's experience (e.g. available throughput, latency, predictability, reliability) is impacted by the utilization of the spectrum by other users in the area. Given the increasing demands for aggregate throughput within wireless spectrum shared by multiple users, and the increasing growth of applications that can rely upon multi-user wireless network reliability, predictability and low latency for a given user, it is apparent that prior art multi-user wireless technology suffers from many limitations. Indeed, with the limited availability of spectrum suitable for particular types of wireless communications (e.g. at wavelengths that are efficient in penetrating building walls), prior art wireless techniques will be insufficient to meet the increasing demands for bandwidth that is reliable, predictable and low-latency.

Prior art intra-cell diversity and multiplexing methods can only provide up to a theoretical 4× increase in throughput over current cellular networks for LTE (through MIMO 4×4) or at most a theoretical 8× for LTE-Advanced (through MIMO 8×8), although higher orders of MIMO achieve diminishing improvements in increasing throughput in a given multipath environment, particularly as UEs (such as smartphones) get smaller and more constrained in terms of antenna placement. Other marginal throughput gains in next generation cellular systems may be obtained from additional spectrum allocation (e.g., FCC national broadband plan), exploited via carrier aggregation techniques, and more dense distribution of BTSs via small cell networks and SON [References 30,46]. All the above techniques, however, still rely heavily on spectrum or time sharing techniques to enable multi-user transmissions, since the spectral efficiency gains obtained by spatial processing is limited.

While prior art inter-cell methods (e.g., network MIMO and CoMP systems [References 53-64]) can improve reliability of cellular networks by eliminating inter-cell interference, their capacity gains are only marginal. In fact, those systems constrain power transmitted from every BTS to be contained within the cell boundaries and are only effective to eliminate inter-cell interference due to power leakage across cells. FIG. 3 shows one example of cellular networks with three BTSs, each one characterized by its own coverage area or cell. The power transmitted from each BTS is constrained to limit the amount of interference across cells, depicted in FIG. 3 by the areas where the cells overlap. As these systems operate in the low SINR regime at the interference region, their gains in spectral efficiency is only marginal, similarly to intra-cell schemes for SU-MIMO. To truly obtain significant capacity gains in inter-cell cooperative networks, power constraints limited to cell-boundaries must be relaxed and spatial multiplexing techniques should be enabled throughout the cells where the SINR is high (not just at the cell-edge with poor SINR performance as in prior art approaches).

FIG. 4 shows the case where the power transmitted from the three BTSs 401 all transmitting simultaneously at the same frequency is increased, thereby allowing a higher level of interference throughout the cell 402. In prior art systems, such interference would result in incoherent interference (disrupting UE signal reception) throughout the interfering areas of the BTSs, but this interference is actually exploited in the present invention through novel inter-cell multiplexing methods using spatial processing to create areas of coherent interference (enhancing UE signal reception) around every UE, thereby providing simultaneous non-interfering data streams to every UE and increasing their SINR throughout the cell.

The scenario depicted in FIG. 4 is described in [Reference 89] for the particular case of cellular systems. The system in [Reference 89] consists of several BTSs identifying different cells that are grouped into clusters. Cooperation is allowed only across BTSs from adjacent cells within the same clusters. In this case it was shown that, as the power transmitted from the BTSs increases, there is a limit to the capacity (or spectral efficiency) achievable through inter-cell multiplexing methods. In fact, as the transmit power increases, the out-of-cluster interference increases proportionally, producing a saturation regime for the SINR and consequently for the capacity. As a consequence of this effect, the system in [Reference 89] can theoretically achieve at most 3× gain in capacity (i.e., at most three cells within the cluster) and any additional cell included in the cluster would reduce capacity due to increased out-of-cluster interference (e.g., the case of 21 cells per cluster yields lower capacity than the case of 3 cells per cluster). We observe that the fundamental capacity limit in [Reference 89] holds because the BTSs are constrained to predefined locations, as in cellular systems, and multiplexing gain is achieved by increasing transmit power from the BTSs. To obtain theoretically unlimited capacity gain via inter-cell multiplexing methods, the constraint on the BTS placement must be removed, allowing the BTSs to be placed anywhere is convenient.

It would thus be desirable to provide a system that achieves orders of magnitudes increase in spectral efficiency exploiting inter-cell multiplexing gain via spatial processing by removing any constraint on the power transmitted from distributed BTSs 501 as well as on their placement. FIG. 5 shows one example where many additional access points 502 are added to deliberately increase the level of incoherent interference throughout the cell 503, that is exploited in the present invention to generate areas of coherent interference around UEs, thereby yielding theoretically unlimited inter-cell multiplexing gain. The additional access points are placed serendipitously wherever it is convenient and are not constrained to any specific cell planning, as in cellular systems described in prior art. In an exemplary embodiment of the invention, the serendipitous access points are distributed-input distributed-output (DIDO) access points and the inter-cell multiplexing gain is achieved through DIDO methods described in Related Patents and Applications and [References 77-78]. In another embodiment, the serendipitous access points are low power transceivers, similar to inexpensive Wi-Fi access points or small-cells [References 30,47], thereby providing smaller areas of coverage overlapping throughout the macro-cell as shown in FIG. 5.

We observe that prior art inter-cell methods [References 53-64] avoid incoherent interference by intentionally limiting the transmit power from every BTS as in FIG. 3 and eliminate residual inter-cell interference (on the overlapping areas between cells) via spatial processing, thereby providing improved SINR and inter-cell diversity gain. We further observe that [Reference 89] constrains BTS placement to cell planning while increasing transmit power, thereby limiting the achievable capacity due to out-of-cluster interference, and as such it is still limited by interference. By contrast, the present invention exploits incoherent interference to create coherent interference around the UEs, by transmitting higher power from every BTS serendipitously placed, thereby improving signal quality at the UE that is necessary condition to obtain inter-cell multiplexing gain throughout the cell via spatial processing. As such, the systems described in prior art cannot be used to achieve unlimited inter-cell multiplexing gain via spatial processing, since there is not sufficient SINR throughout the cell (due to the limited transmit power from the BTSs or the out-of-cluster interference when transmit power is increased) to enable inter-cell multiplexing methods as in the present invention. Moreover, the systems described in prior art would be inoperable to achieve the multiplexing gain achieved in the present invention depicted in FIGS. 4-5, given that prior art systems were designed to avoid inter-cell interference within the diversity regions shown in the shaded area of FIG. 1 and FIGS. 3-5 rather than exploit inter-cell interference in the multiplexing regions to obtain inter-cell multiplexing gain as achieved in the present invention.

### BRIEF DESCRIPTION OF THE DRAWINGS

A better understanding of the present invention can be obtained from the following detailed description in conjunction with the drawings, in which:

FIG. 1 illustrates multiplexing and diversity regions for a macro-cell and a small-cell.

FIG. 2A illustrates full frequency reuse pattern in conventional cellular systems.

FIG. 2B illustrates hard frequency reuse (HFR) pattern in conventional cellular systems.

FIG. 2C illustrates fractional frequency reuse (FFR) pattern in conventional cellular systems.

FIG. 3 illustrates the interference region between adjacent macro-cells.

FIG. 4 illustrates multiple BTSs transmitting at higher power to increase the level of interference between cells.

FIG. 5 illustrates one example where many access points are added to deliberately increase the level of incoherent interference throughout the cell.

FIG. 6 illustrates the network elements in LTE networks.

FIG. 7A illustrates the LTE frame structure for FDD operation.

FIG. 7B illustrates the LTE frame structure for TDD operation.

FIG. 8A illustrates the LTE “resource elements” and “resource blocks” in the OFDM DL channel.

FIG. 8B illustrates the LTE “resource elements” and “resource blocks” in the SC-FDMA UL channel.

FIG. 9 illustrates one embodiment of a multi-user (MU) multiple antenna system (MAS), or MU-MAS, consisting of antenna-clusters and user-clusters.

FIG. 10 illustrates one embodiment of a MU-MAS wherein a different cell ID is associated to every antenna-subcluster.

FIG. 11 illustrates one embodiment of a MU-MAS wherein the same set of cell IDs are assigned to the antenna-subclusters with given repetition pattern.

FIG. 12 illustrates the SNR distribution for practical deployment of MU-MAS systems in downtown San Francisco, CA, with sparsely and densely populated areas.

FIG. 13 illustrates one embodiment of a MU-MAS consisting of CP, distributed BTSs and multiple UEs.

FIG. 14 illustrates one embodiment of a MU-MAS consisting of CP, distributed BTSs, multiple devices and one UE connected to the devices as well as the BTSs via network interfaces.

FIG. 15 illustrates one embodiment of a MU-MAS wherein the UE is in a case that physically attaches to the user device.

FIG. 16 illustrates one embodiment of a MU-MAS wherein the distributed antennas communicate to the UEs via the UL and DL channels.

FIG. 17 illustrates one embodiment of a MU-MAS wherein the distributed antennas communicate to the beacon via the UL and DL channels.

FIG. 18 illustrates the symbol error rate (SER) performance of the MU-MAS with linear precoding with/without RF mismatch and with/without RF calibration.

FIG. 19 illustrates the symbol error rate (SER) performance of the MU-MAS with linear and non-linear precoding with/without RF mismatch and with/without RF calibration.

FIGS. 20A-B illustrates the 4-QAM constellations at the UEs (before modulo operation) when applying THP non-linear precoding.

### DETAILED DESCRIPTION

One solution to overcome many of the above prior art limitations is an embodiment of Distributed-Input Distributed-Output (DIDO) technology. DIDO technology is described in the following patents and patent applications, all of which are assigned the assignee of the present patent and are incorporated by reference. These patents and applications are sometimes referred to collectively herein as the “Related Patents and Applications.”

U.S. application Ser. No. 13/633,702, entitled “Systems and Methods for wireless backhaul in distributed-input distributed-output wireless systems”

U.S. application Ser. No. 13/475,598, entitled “Systems and Methods to enhance spatial diversity in distributed-input distributed-output wireless systems”

U.S. application Ser. No. 13/233,006, entitled “System and Methods for planned evolution and obsolescence of multiuser spectrum”

U.S. application Ser. No. 13/232,996, entitled “Systems and Methods to Exploit Areas of Coherence in Wireless Systems”

U.S. application Ser. No. 13/464,648, entitled “System and Methods to Compensate for Doppler Effects in Distributed-Input Distributed Output Systems”

U.S. application Ser. No. 12/917,257, entitled “Systems And Methods To Coordinate Transmissions In Distributed Wireless Systems Via User Clustering”

U.S. application Ser. No. 12/802,988, entitled “Interference Management, Handoff, Power Control And Link Adaptation In Distributed-Input Distributed-Output (DIDO) Communication Systems”

U.S. application Ser. No. 12/802,974, entitled “System And Method For Managing Inter-Cluster Handoff Of Clients Which Traverse Multiple DIDO Clusters”

U.S. application Ser. No. 12/802,989, entitled “System And Method For Managing Handoff Of A Client Between Different Distributed-Input-Distributed-Output (DIDO) Networks Based On Detected Velocity Of The Client”

U.S. application Ser. No. 12/802,958, entitled “System And Method For Power Control And Antenna Grouping In A Distributed-Input-Distributed-Output (DIDO) Network”

U.S. application Ser. No. 12/802,975, entitled “System And Method For Link adaptation In DIDO Multicarrier Systems”

U.S. application Ser. No. 12/802,938, entitled “System And Method For DIDO Precoding Interpolation In Multicarrier Systems”

U.S. application Ser. No. 12/630,627, entitled “System and Method For Distributed Antenna Wireless Communications”

U.S. Pat. No. 8,170,081, issued May 1, 2012, entitled “System And Method For Adjusting DIDO Interference Cancellation Based On Signal Strength Measurements”

U.S. Pat. No. 8,160,121, issued Apr. 17, 2012, entitled, “System and Method For Distributed Input-Distributed Output Wireless Communications”;

U.S. Pat. No. 7,885,354, issued Feb. 8, 2011, entitled “System and Method For Enhancing Near Vertical Incidence Skywave (“NVIS”) Communication Using Space-Time Coding.”

U.S. Pat. No. 7,711,030, issued May 4, 2010, entitled “System and Method For Spatial-Multiplexed Tropospheric Scatter Communications”;

U.S. Pat. No. 7,636,381, issued Dec. 22, 2009, entitled “System and Method for Distributed Input Distributed Output Wireless Communication”;

U.S. Pat. No. 7,633,994, issued Dec. 15, 2009, entitled “System and Method for Distributed Input Distributed Output Wireless Communication”;

U.S. Pat. No. 7,599,420, issued Oct. 6, 2009, entitled “System and Method for Distributed Input Distributed Output Wireless Communication”;

U.S. Pat. No. 7,418,053, issued Aug. 26, 2008, entitled “System and Method for Distributed Input Distributed Output Wireless Communication”;

To reduce the size and complexity of the present patent application, the disclosure of some of the Related Patents and Applications is not explicitly set forth below. Please see the Related Patents and Applications for a full description of the disclosure.

The present invention describes system and methods to exploit inter-cell multiplexing gain in wireless communications networks via spatial processing, employing a multiple antenna system (MAS) with multi-user (MU) transmissions (a Multi-User Multiple Antenna System, or “MU-MAS”), where the multiple antennas are placed serendipitously. In one embodiment of the invention, the power transmitted from the multiple antennas is constrained to minimize interference at cell boundaries (as in conventional cellular systems) and spatial processing methods are employed only to eliminate inter-cell interference. In another embodiment of the invention, the power transmitted from the multiple antennas is not constrained to any particular power level (as long as their power emission level falls within the regulatory, safety or practical (e.g. available power, transmitter and/or antenna specifications) limits), thereby creating intentionally higher levels of inter-cell interference throughout the cell that is exploited to achieve inter-cell multiplexing gain and increase the capacity of the wireless communications network.

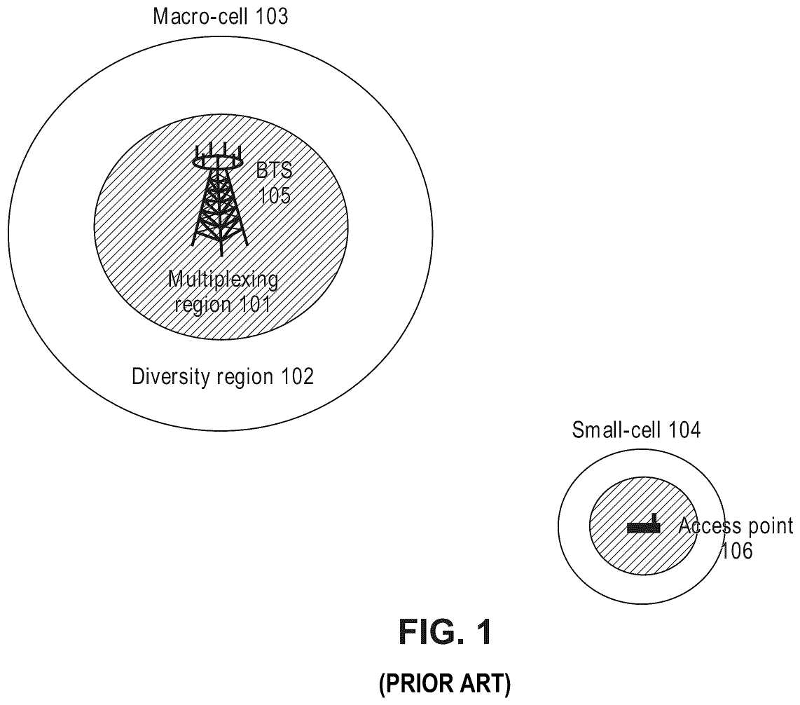

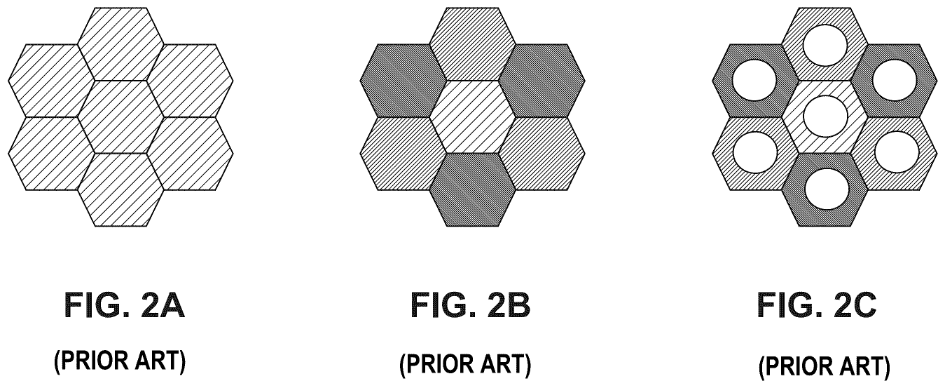

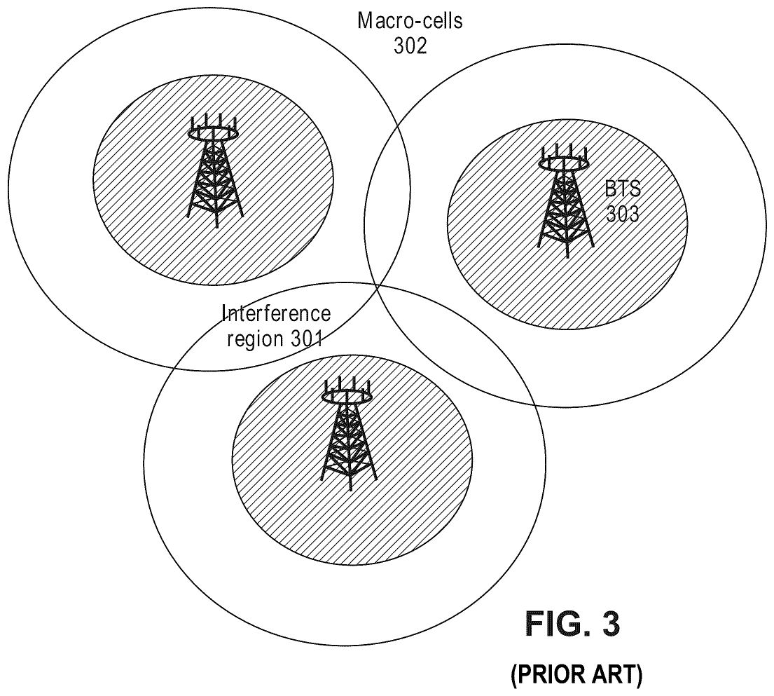

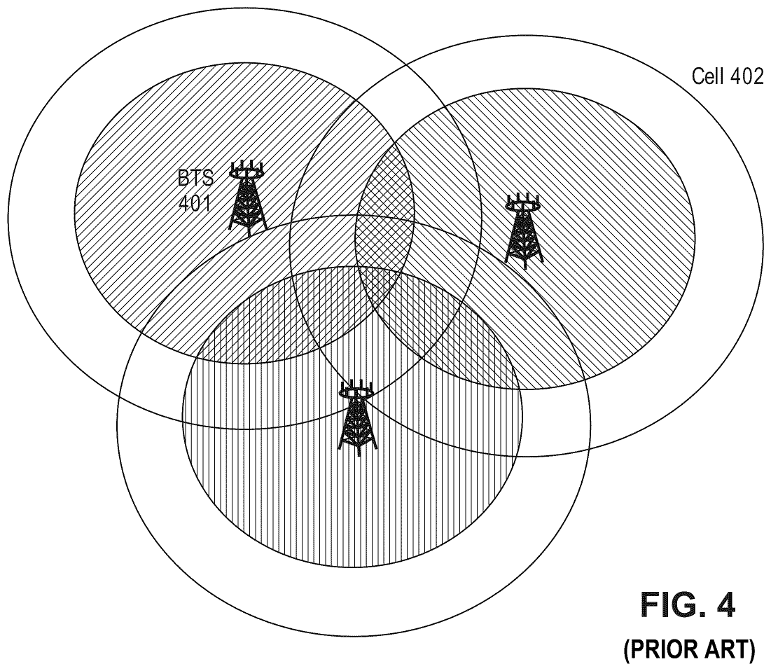

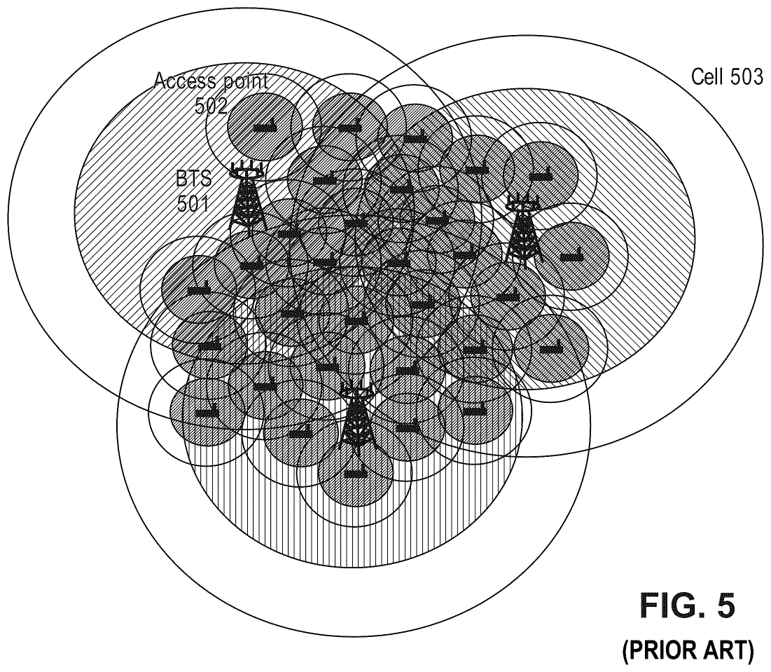

In one embodiment, the wireless communications network is a cellular network as in FIGS. 1 and 3, such as a cellular network based on LTE standards and the multiple antennas serendipitously deployed are transceivers for macro-cells or small-cells. In another embodiment of the invention, the wireless communications network is not constrained to any particular cell layout and the cell boundaries can extend over larger areas as in FIGS. 4-5. For example, the wireless communications network could be a wireless local area network (WLAN) with multiple antennas being WiFi access points, or a mesh, ad-hoc or sensor network, or a distributed antenna system, or a DIDO system with access points placed serendipitously without any transmit power constraint. But, such example network structures should not be considered as limiting the general applicability of the present invention to wireless communications networks. The present invention applies to any wireless network where multiplexing gain is achieved by transmitting signals from multiple antennas that interfere where received by multiple UEs so as to create simultaneous non-interfering data streams to multiple UEs.

The MU-MAS consists of a centralized processor, a network and M transceiver stations (or distributed antennas) communicating wirelessly to N client devices or UEs. The centralized processor unit receives N streams of information with different network content (e.g., videos, web-pages, video games, text, voice, etc., streamed from Web servers or other network sources) intended for different client devices. Hereafter, we use the term “stream of information” to refer to any stream of data sent over the network containing information that can be demodulated or decoded as a standalone stream, according to certain modulation/coding scheme or protocol, to produce any data, including but not limited to audio, Web and video content. In one embodiment, the stream of information is a sequence of bits carrying network content that can be demodulated or decoded as a standalone stream.

The centralized processor utilizes precoding transformation to combine (according to algorithms, such as those described in the Related Patents and Applications) the N streams of information from the network content into M streams of bits. By way of example, but not limitation, the precoding transformation can be linear (e.g., zero-forcing [Reference 65], block-diagonalization [References 66-67], matrix inversion, etc.) or non-linear (e.g., dirty-paper coding [References 68-70] or Tomlinson-Harashima precoding [References 71-72], lattice techniques or trellis precoding [References 73-74], vector perturbation techniques [References 75-76]). Hereafter, we use the term “stream of bits” to refer to any sequence of bits that does not necessarily contain any useful bit of information and as such cannot be demodulated or decoded as a standalone stream to retrieve the network content. In one embodiment of the invention, the stream of bits is the complex baseband signal produced by the centralized processor and quantized over given number of bits to be sent to one of the M transceiver stations.

Precoding is computed at the centralized processor by employing the Channel State Information (CSI) and applied over the DL or UL channels to multiplex data streams to or from multiple users. In one embodiment of the invention, the centralized processor is aware of the CSI between the distributed antennas and the client devices, and utilizes the CSI to precode data sent over the DL or UL channels. In the same embodiment, the CSI is estimated at the client devices and fed back to the distributed antennas. In another embodiment, the DL-CSI is derived at the distributed antennas from the UL-CSI using radio frequency (RF) calibration and exploiting UL/DL channel reciprocity.

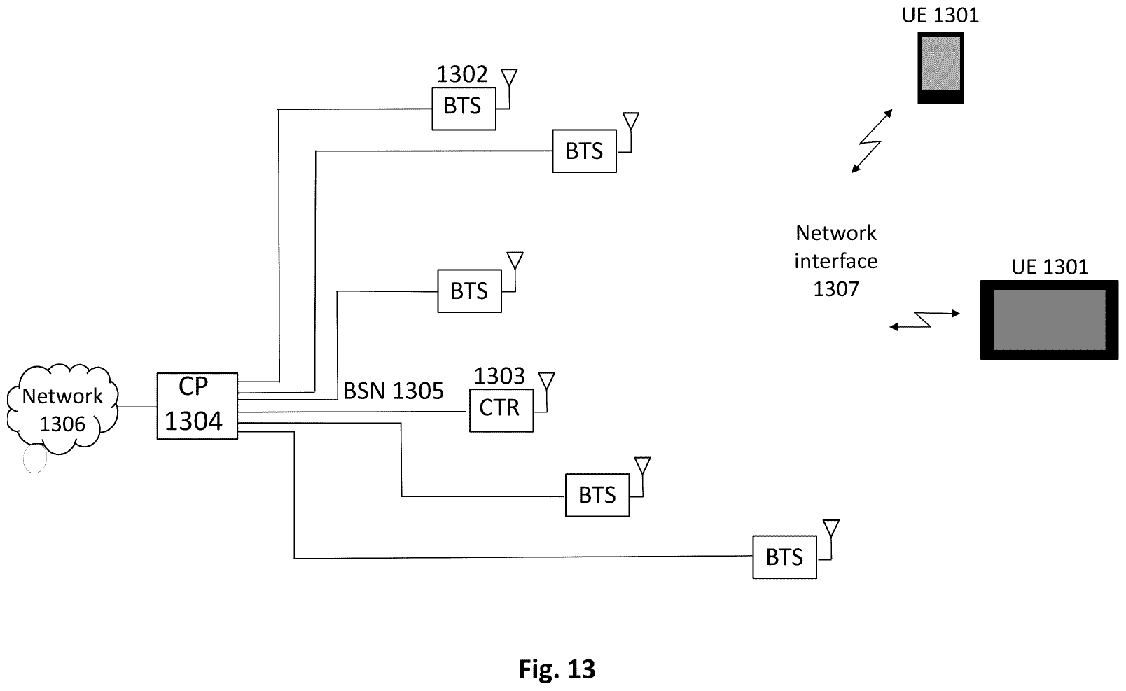

In one embodiment, the MU-MAS is a distributed-input distributed-output (DIDO) system as described in Related Patents and Patent Applications. In another embodiment, the MU-MAS depicted in FIG. 13 consists of:
User Equipment (UE) 1301: An RF transceiver for fixed and/or mobile clients receiving data streams over the downlink (DL) channel from the backhaul and transmitting data to the backhaul via the uplink (UL) channel
Base Transceiver Station (BTS) 1302: The BTSs interface the backhaul with the wireless channel. BTSs of one embodiment are access points consisting of Digital-to-Analog Converter (DAC)/Analog-to-Digital Converter (ADC) and radio frequency (RF) chain to convert the baseband signal to RF. In some cases, the BTS is a simple RF transceiver equipped with power amplifier/antenna and the RF signal is carried to the BTS via RF-over-fiber technology as described in Related Patents and Applications.
Controller (CTR) 1303: A CTR is one particular type of BTS designed for certain specialized features such as transmitting training signals for time/frequency synchronization of the BTSs and/or the UEs, receiving/transmitting control information from/to the UEs, receiving the channel state information (CSI) or channel quality information from the UEs. One or multiple CTR stations can be included in any MU-MAS system. When multiple CTRs are available, the information to or from those stations can be combined to increase diversity and improve link quality. In one embodiment, the CSI is received from multiple CTRs via maximum ratio combining (MRC) techniques to improve CSI demodulation. In another embodiment, the control information is sent from multiple CTRs via maximum ratio transmission (MRT) to improve SNR at the receiver side. The scope of the invention is not limited to MRC or MRT, and any other diversity technique (such as antenna selection, etc.) can be employed to improve wireless links between CTRs and UEs.
Centralized Processor (CP) 1304: The CP is a server interfacing the Internet or other types of external networks 1306 with the backhaul. In one embodiment, the CP computes the MU-MAS baseband processing and sends the waveforms to the distributed BTSs for DL transmission
Base Station Network (BSN) 1305: The BSN is the network connecting the CP to the distributed BTSs carrying information for either the DL or the UL channel. The BSN is a wireline or a wireless network or a combination of the two. For example, the BSN is a DSL, cable, optical fiber network, or Line-of-Sight (LOS) or Non-Line-of-Sight (NLOS) wireless link. Furthermore, the BSN is a proprietary network, or a local area network, or the Internet.

Hereafter we describe how the above MU-MAS framework is incorporated into the LTE standard for cellular systems (and also non-cellular system utilizing LTE protocols) to achieve additional gains in spectral efficiency. We begin with a general overview of LTE framework and modulation techniques employed in the DL and UL channels. Then we provide a brief description of the physical layer frame structure and resource allocation in the LTE standard. Finally, we define MU-MAS precoding methods for downlink (DL) and uplink (UL) channels in multi-user scenarios using the LTE framework. For the DL schemes, we propose two solutions: open-loop and closed-loop DIDO schemes.

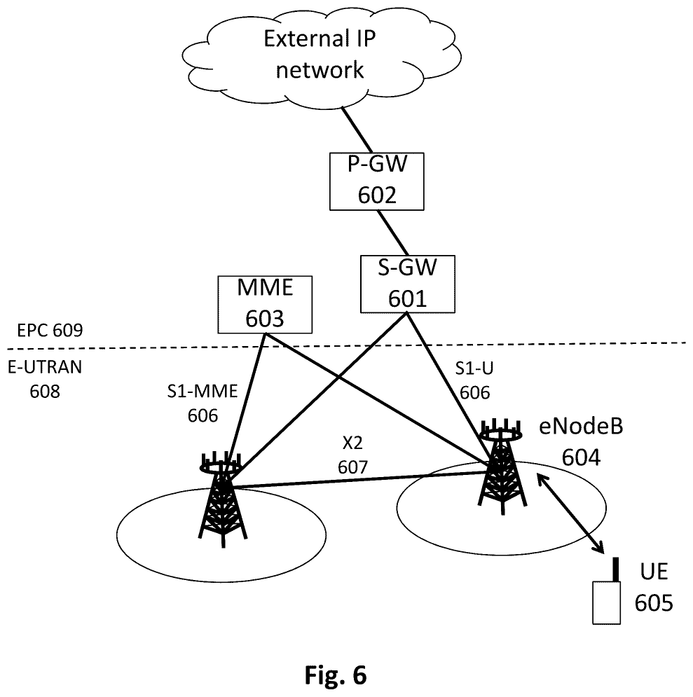

LTE is designed with a flat network architecture (as opposed a hierarchical architecture from previous cellular standards) to provide: reduced latency, reduced packet losses via ARQ, reduced call setup time, improved coverage and throughput via macro-diversity. The network elements in LTE networks depicted in FIG. 6 are per [Reference 79]:
GW (gateway): is the router connecting the LTE network to external networks (i.e., the Internet). The GW is split into serving gateway (S-GW) 601 that terminates the E-UTRAN interface 608 and PDN gateway (P-GW) 602 being the interface with external networks. The S-GW and P-GW are part of the so called evolved packet core (EPC) 609;
MME (mobility management entity) 603: manages mobility, security parameters and UE identity. The MME is also part of the LTE EPC;
eNodeB (enhanced Node-B) 604: is the base station handling radio resource management, user mobility and scheduling;
UE (user equipment) 605: is the mobile station.
S1 and X2 interfaces (606 and 607): are the wireline or wireless backhauls between the MME and eNodeBs (S1-MME), the S-GW and eNodeBs (S1-U) and between multiple eNodeBs (X2).

In one embodiment of the invention, the MU-MAS network is an LTE network wherein the UE is the LTE UE, the BTS is the LTE eNodeB, the CTR is the LTE eNodeB or MME, the CP is the LTE GW, the BSN is the S1 or X1 interface. Hereafter we use the terms distributed antennas, BTS and eNodeB interchangeably to refer to any base station in MU-MAS, DIDO or LTE systems.

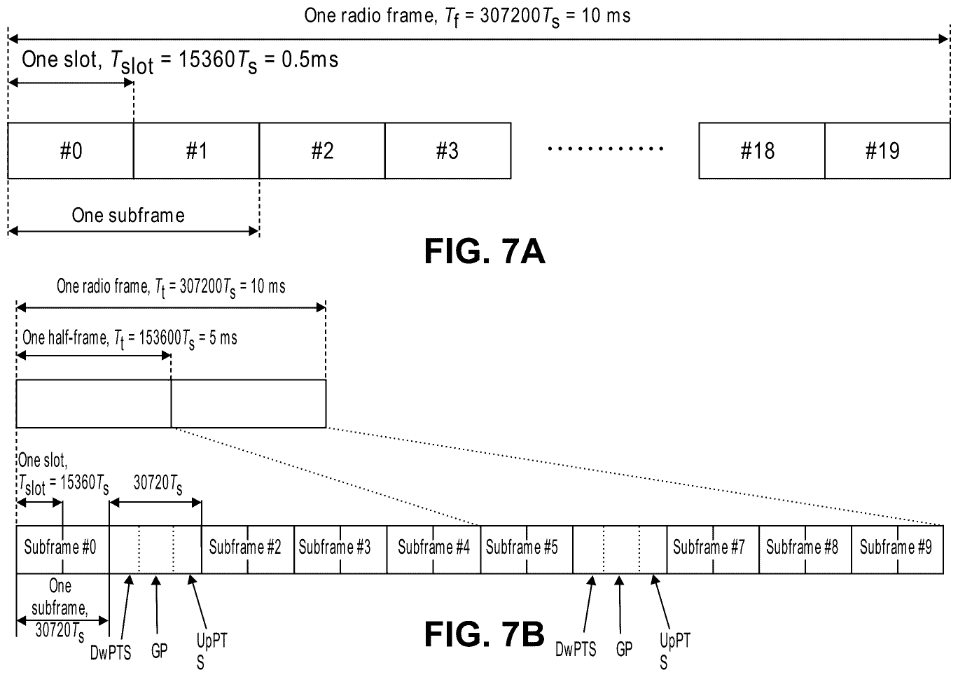

The LTE frame has duration of 10 msec and consists of ten subframes as depicted in FIG. 7 [References 33,80]. Every subframe is divided in two slots of duration 0.5 msec each. The LTE standards defines two types of frames: i) type 1 for FDD operation as in FIG. 7a), where all subframes are assigned either for the DL or UL channels; ii) type 2 for TDD operation as in FIG. 7b), where, part of the subframes are assigned to the DL and part to the UL (depending on the selected configuration), whereas a few subframes are reserved for “special use”. These is at least one special subframe per frame and it consists of three fields: i) downlink pilot time slot (DwPTS) reserved for DL transmission; ii) guard period (GP); iii) uplink pilot time slot (UpPTS), for UL transmission.

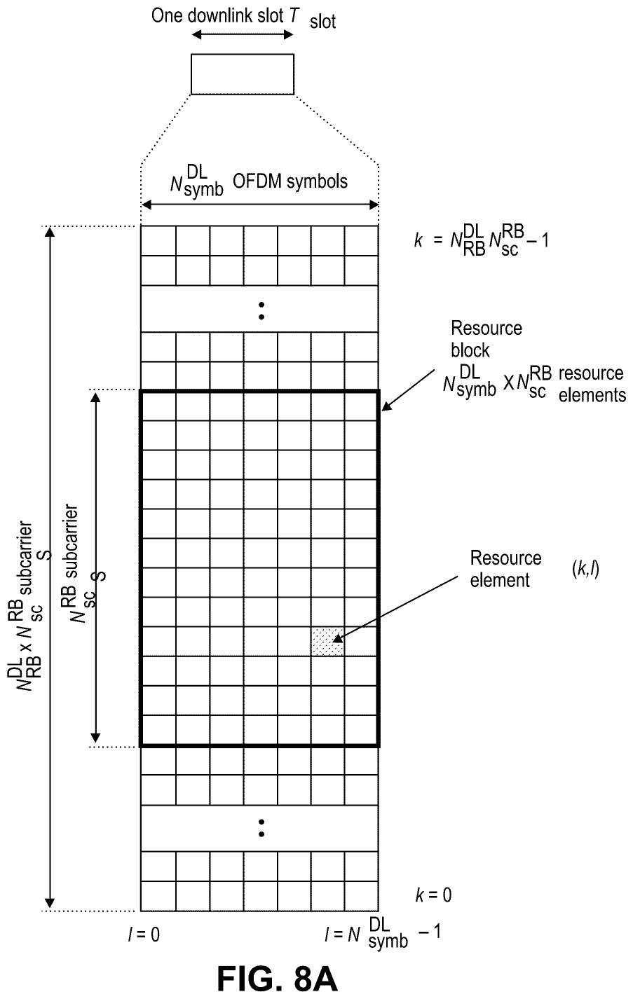

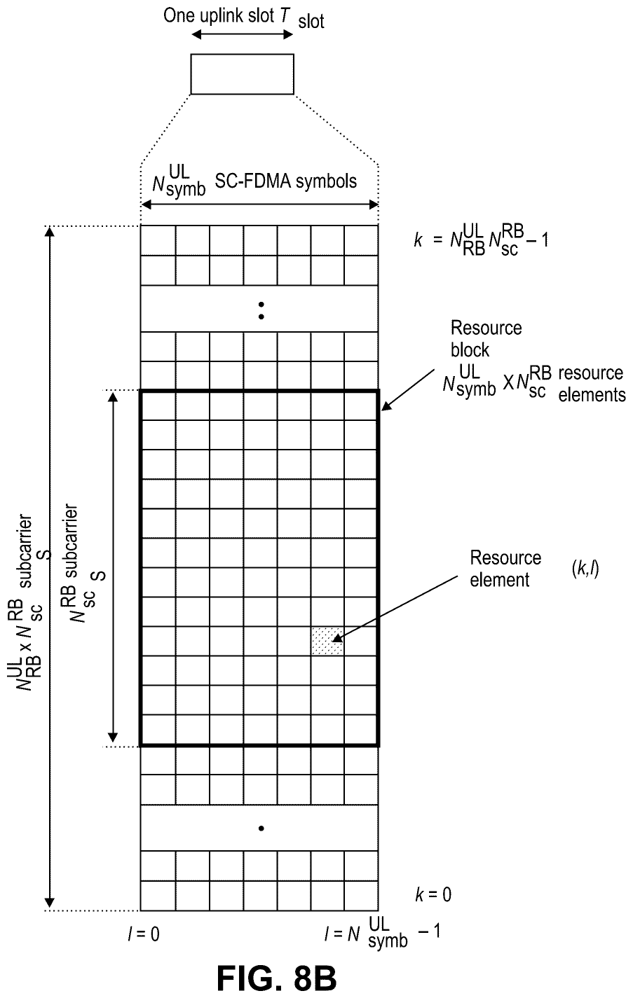

LTE employs orthogonal frequency division multiplexing (OFDM) and orthogonal frequency division multiple access (OFDMA) modulation for the DL and single-carrier frequency division multiple access (SC-FDMA) for the UL. The “resource element” (RE) is the smallest modulation structure in LTE and consists of one OFDM subcarrier in frequency and one OFDM symbol duration in time, as shown in FIG. 8a for the DL channel and in FIG. 8b for the UL channel. The “resource block” (RB) consists of 12 subcarriers in frequency and one 0.5 msec slot in time (consisting of 3 to 7 OFDM symbol periods, depending on DL versus UL channel and type of cyclic prefix). Resource blocks for every UE are assigned on a subframe basis. Since the MU-MAS in the present invention uses spatial processing to send multiple data streams to different UEs, at every subframe all resource blocks can be allocated to the same UE. In one embodiment, all or a subset of resource blocks are allocated to every UE and simultaneous non-interfering data streams are sent to the UEs via precoding.

To setup the link between the BTS and the UEs, the LTE standard defines the synchronization procedure. The BTS sends two consecutive signals to the UE: the primary synchronization signal (P-SS) sent over the primary synchronization channel (PSCH) and the secondary synchronization signal (S-SS) sent over the secondary synchronization channel (SSCH). Both signals are used by the UE for time/frequency synchronization as well as to retrieve the cell ID. The P-SS consists of length-63 Zadoff-Chu sequence from which the UE derives the physical layer ID (0 to 2). The S-SS is an interleaved concatenation of two length-31 binary sequences and is used to derive the cell ID group number (0 to 167). From the two identity numbers above, the UE derives the physical cell ID (PCI, defined from 0 to 503).

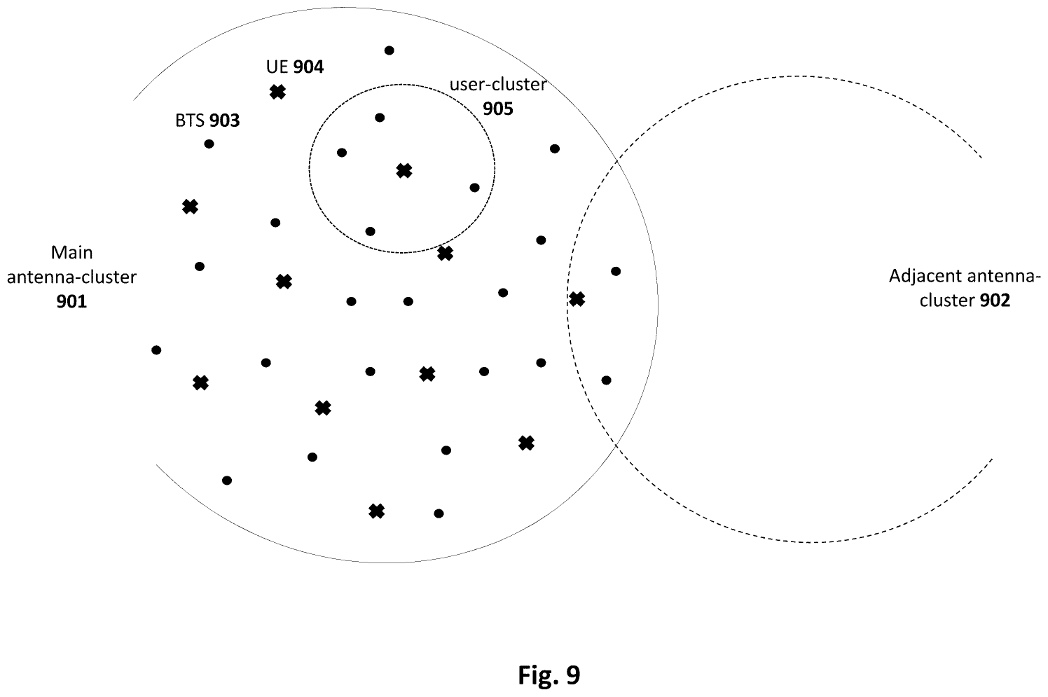

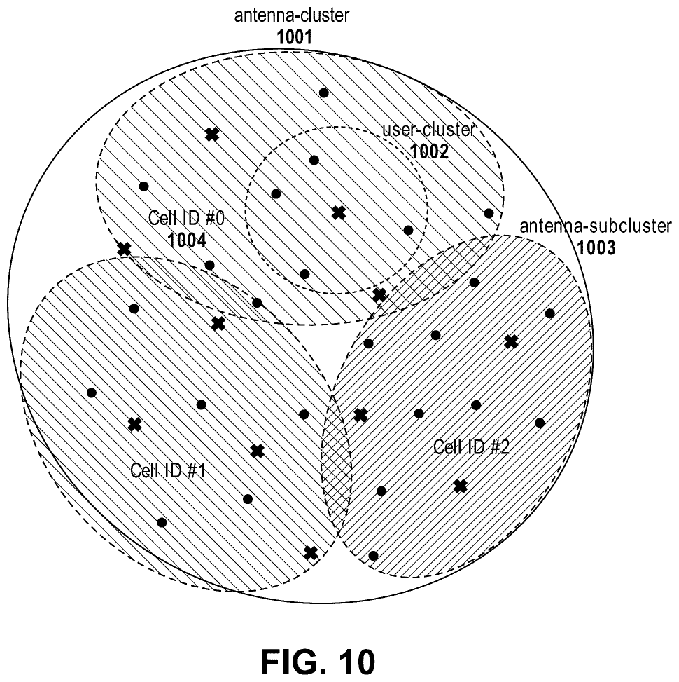

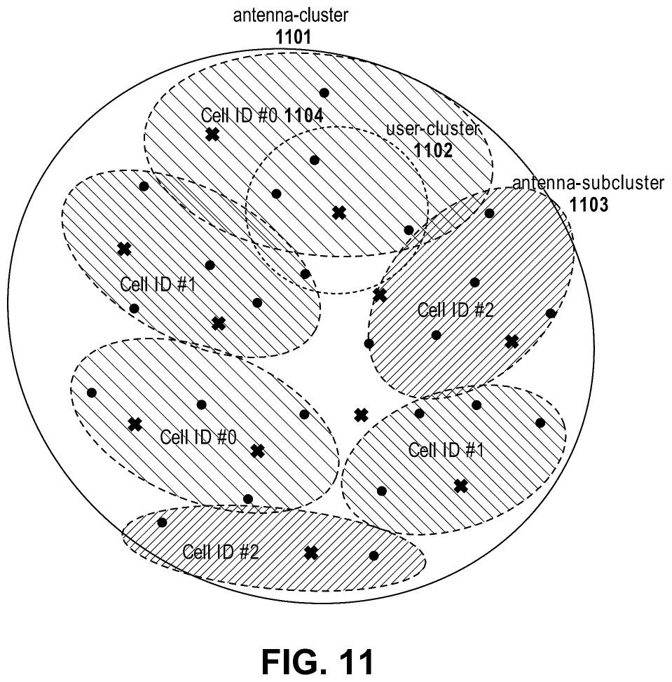

In the MU-MAS system described in the present invention, there are no cell boundaries as the power transmitted from the BTSs is increased intentionally to produce interference that is exploited to create areas of coherence around the UEs. In the present invention, different BTSs are grouped into “antenna-clusters” or “DIDO-clusters” as defined in related U.S. Pat. No. 8,170,081, issued May 1, 2012, entitled “System And Method For Adjusting DIDO Interference Cancellation Based On Signal Strength Measurements”. For example, FIG. 9 shows the main antenna-cluster 901 and one adjacent antenna-cluster 902. Every antenna-cluster consists of multiple BTSs 903.

The cell ID can be used in MU-MAS and DIDO systems to differentiate the antenna-clusters. In one embodiment of the invention, the same cell ID is transmitted from all BTSs of the same antenna-cluster via the P-SS and S-SS. In the same embodiment, different antenna-clusters employ different cell IDs. In another embodiment of the invention, all BTSs within the same antenna-cluster 1001 are grouped into “antenna-subclusters” 1003 depicted in FIG. 10 with different shaded colors and a different cell ID 1004 is associated to every antenna-subcluster. In one embodiment, the antenna-subclusters are defined statically according to predefined cluster planning or based on GPS positioning information. In another embodiment, the antenna-subclusters are defined dynamically based on measurements of relative signal strength between BTSs or GPS positioning information. In a different embodiment of the invention, a different cell ID is assigned to every area of coherence (described in related co-pending U.S. application Ser. No. 13/232,996, entitled “Systems and Methods to Exploit Areas of Coherence in Wireless Systems”) associated to the UEs.

When all BTSs within the same antenna-cluster or antenna-subcluster transmit the LTE broadcast channels (e.g., P-SS and S-SS) to the UEs, destructive interference may degrade the performance of time or frequency synchronization enabled by the broadcast channel. Destructive interference may be caused by multipaths generated from spatially distributed BTSs that recombine incoherently at some UE locations. To avoid or mitigate this effect, in one embodiment of the invention, only one BTS out of all BTSs within the same antenna-cluster or antenna-subcluster transmits the LTE broadcast channels (e.g., P-SS and S-SS) to all UEs. In the same embodiment, the BTS that transmits the LTE broadcast channels is selected to maximize the power received at the UEs over the broadcast channels. In another embodiment, only a limited set of BTSs is selected to transmit simultaneously the LTE broadcast channels to all UEs, such that destructive interference is avoided at the UE. In a different embodiment of the invention, the LTE broadcast channels are sent at higher power than the payload to reach all the UEs within the same antenna-cluster or antenna-subcluster.

As described above, LTE-Advanced supports carrier aggregation (CA) schemes to increase data rate over the DL channel. In MU-MASs, CA can be used in combination with precoding to increase per-user data rate. In one embodiment of this invention, transmit precoding is applied to different portions of the RF spectrum (inter-band CA) or different bands within the same portion of the spectrum (intra-band CA) to increase per-user data rate. When employing inter-band CA, pathloss at different bands may change significantly as those bands are centered at different carrier frequencies. In conventional LTE cellular systems, frequency bands at lower carrier frequencies may experience lower pathloss than higher carrier frequencies. Hence, applying inter-band CA in cellular systems may cause undesired inter-cell interference at lower carrier frequencies. By contrast, the MU-MAS in the present invention is not limited by interference at the cell boundary as the BTSs are distributed and there is no concept of cell. This more flexible system layout allows different methods for inter-band CA in MU-MAS. In one embodiment of the present invention, the MU-MAS enables inter-band CA by employing one set of BTSs to operate at lower carrier frequencies and another set of BTSs to operate at higher carrier frequencies, such that the two sets intersect or one set is the subset of the other. In another embodiment, the MU-MAS with precoding employs CA methods in conjunction with frequency hopping patterns to improve robustness against frequency-selective fading or interference.

### 1. Downlink Closed-Loop MU-MAS Precoding Methods in LTE

MU-MAS closed-loop schemes can be used either in time-division duplex (TDD) or frequency division duplex (FDD) systems. In FDD systems, DL and UL channels operate at different frequencies and therefore the DL channel state information (CSI) must be estimated at the UE side and reported back to the CP through the BTSs or the CTRs via the UL channel. In TDD systems, DL and UL channels are set at the same frequency and the system may employ either closed-loop techniques or open-loop schemes exploiting channel reciprocity (as described in the following section). The main disadvantage of closed-loop schemes is they require feedback, resulting in larger overhead for control information over the UL.

The general mechanism for closed-loop schemes in MU-MASs is described as follows: i) the BTSs send signaling information to the UEs over the DL; ii) the UEs exploit that signaling information to estimate the DL CSI from all the “active BTSs”; iii) the UEs quantize the DL CSI or use codebooks to select the precoding weights to be used for the next transmission; iv) the UEs send the quantized CSI or the codebook index to the BTSs or CTRs via the UL channel; v) the BTSs or CTRs report the CSI information or codebook index to the CP that calculates the precoding weights for data transmission over the DL. The “active BTSs” are defined as the set of BTSs that are reached by given UE. For example, in related co-pending U.S. application Ser. No. 12/802,974, entitled “System And Method For Managing Inter-Cluster Handoff Of Clients Which Traverse Multiple DIDO Clusters” and related co-pending U.S. application Ser. No. 12/917,257, entitled “Systems And Methods To Coordinate Transmissions In Distributed Wireless Systems Via User Clustering” we defined the “user-cluster” 905 as the set of BTSs that are reached by given UE, as depicted in FIG. 9. The number of active BTSs are limited to a user-cluster so as to reduce the amount of CSI to be estimated from the BTSs to given UE, thereby reducing the feedback overhead over the UL and the complexity of the MU-MAS precoding calculation at the CP.

As described in the Related Patent and Applications, MU-MAS precoding employs either linear or non-linear methods. In the case of non-linear methods (e.g., dirty-paper coding [References 68-70] or Tomlinson-Harashima precoding [References 71-72], lattice techniques or trellis precoding [References 73-74], vector perturbation techniques [References 75-76]), successive interference cancellation is applied at the transmitter to avoid inter-user interference. In this case the precoding matrix is computed accounting for the CSI to all the UEs within the antenna-cluster. Alternatively, linear precoding methods (e.g., zero-forcing [Reference 65], block-diagonalization [References 66-67], matrix inversion, etc.) can be used on a user-cluster basis, since the precoding weights for every UE are computed independent on the other UEs. Depending on the number of UEs and eNodeBs inside the antenna-cluster and user-clusters, linear versus non-linear precoding methods offer different computational performance. For example, if the MU-MAS consists of K UEs per antenna-cluster, M eNodeBs per antenna-cluster and C eNodeBs per user-cluster, the complexity of linear precoding is O(K*C³) whereas for non-linear precoding it is O(M*K²). It is thus desirable to develop a method that dynamically switches between the two types of precoding techniques based on the number if UEs and eNodeBs in MU-MASs to reduce the computational complexity at the CP. In one embodiment of the invention, the MU-MAS employs linear precoding methods. In another embodiment, the MU-MAS employs non-linear precoding methods. In the same embodiment of the invention, the MU-MAS dynamically switches between linear and non-linear precoding methods based on the number of UEs and eNodeBs in the antenna-clusters and user-clusters to reduce computational complexity at the CP. In a different embodiment, the MU-MAS switches between precoding multiplexing methods for UEs experiencing good channel quality (e.g., in the proximity of eNodeBs) and beamforming or diversity methods for UEs with poor link quality (e.g., far away from the eNodeBs).

1.1 Downlink MU-MAS Signaling Methods within the LTE Standard

The LTE standard defines two types of reference signals (RS) that can be used for DL signaling in closed-loop schemes [References 33,50,82-83]: i) cell-specific reference signal (CRS); ii) UE specific RS such as channel state information (CSI) reference signal (CSI-RS) and demodulation RS (DM-RS). The cell-specific RS is not precoded, whereas the UE-specific RS is precoded [Reference 50]. CRS is used in LTE Release 8 that employs SU/MU-MIMO codebook-based techniques with up to four antennas in every cell. LTE-Advanced Release 10 supports non-codebook based SU/MU-MIMO schemes with up to eight transmit antennas as well as CoMP schemes with antennas distributed over different cells. As such, Release 10 allows for more flexible signaling schemes via CSI-RS. In the present invention, we describe how either types of signaling schemes can be used in MU-MAS systems to enable precoding.

### 1.1.1 Mu-MAS Signalinq Using CRS

The CRS is employed in LTE (Release 8) systems to estimate the CSI from all transmit antennas at the BTS to the UE [References 80,84]. The CRS is obtained as the product of a two-dimensional orthogonal sequence and a two-dimensional pseudo-random numerical (PRN) sequence. There are 3 orthogonal sequences (i.e., placed on orthogonal sets of OFDM subcarriers) and 168 possible PRN sequences, for a total of 504 different CRS sequences. Every sequence uniquely identifies one cell. Each of the three orthogonal CRSs is associated to one of the three physical layer IDs (0 to 2) that generate a different cell ID, as explained in the previous subsection. The CRS is transmitted within the first and third-last OFDM symbol of every slot, and every sixth subcarrier. Orthogonal patterns in time and frequency are designed for every transmit antenna of the BTS, for the UE to uniquely estimate the CSI from each of transmit antennas. Release 8 defines up to four orthogonal patters per CRS, one for each of the four transmit antennas employed in MIMO 4×4. This high density of CRS in time and frequency (i.e., sent every slot of 0.5 msec, and every sixth subcarrier), producing 5% overhead, was designed intentionally to support scenarios with fast channel variations over time and frequency [Reference 83].

In Release 8, since there are up to 3 orthogonal CRSs with 4 orthogonal patterns each for multi-antenna modes (or 6 orthogonal CRSs for single antenna mode), it is possible to discriminate up to 12 transmit antennas within the same coverage area, without causing interference to the CRS. In one embodiment of the invention, the antenna-cluster 1001 is divided into three antenna-subclusters 1005 as in FIG. 10. Different physical layer IDs (or cell IDs) are associated to each of the antenna-subclusters, such that each antenna-subcluster is assigned with one of the three orthogonal CRSs with four orthogonal patterns (i.e., each antenna-subcluster can support up to four BTS without causing interference to the CRS from other BTSs). In this embodiment, every cluster can support up to 12 BTSs without causing interference to the CRS.

In scenarios where more than twelve BTSs are placed within the same cluster, it is desirable to increase the number of available orthogonal CRSs to support larger number of active BTSs (i.e., BTSs that simultaneously transmit precoded signals to the UEs). One way to achieve that is to define more than three antenna-subclusters 1003 per antenna-cluster 1101 and assign the same three physical layer IDs (or cell ID 1104 from 0 to 2) to the antenna-subclusters 1103 with a repetition pattern as shown in FIG. 11. We observe that the antenna-subclusters may come in different shapes and are defined in such a way that every user-cluster 1102 cannot reach two antenna-subclusters with the same physical layer ID, thereby avoiding interference to the CRS. For example, one way to achieve that is to define the area of the antenna-subcluster 1103 larger than the user-cluster 1102 and avoid that adjacent antenna-subcluster use the same physical layer ID. In one embodiment of the invention, the multiple antenna-subclusters are placed within the same antenna-cluster with repetition patterns such that their respective CRSs do not interfere, thereby enabling simultaneous non-interfering transmissions from more than twelve BTSs.

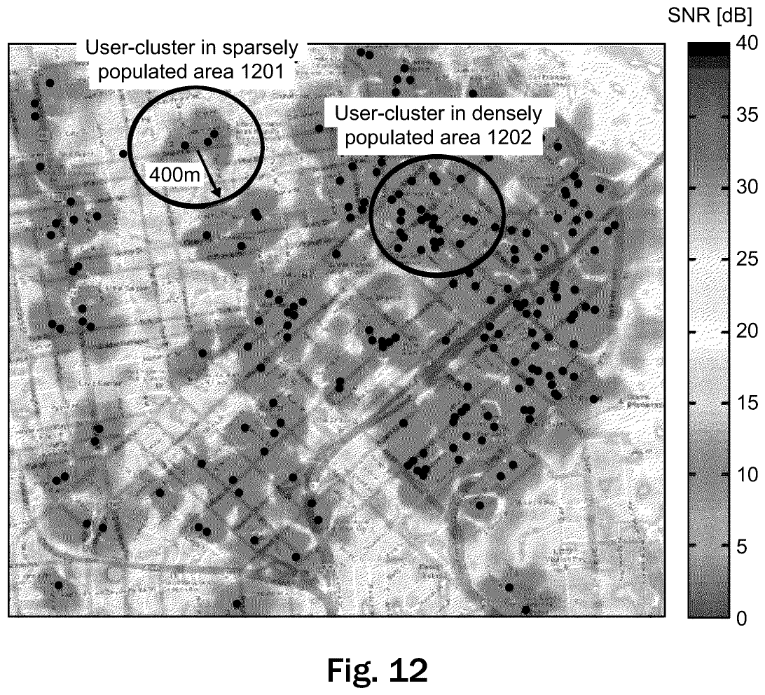

In practical MU-MAS systems, it may be the case that every UE sees more than only four BTSs within its user-cluster. For example, FIG. 12 shows the SNR distribution for practical deployment of DIDO or MU-MAS systems in downtown San Francisco, CA. The propagation model is based on 3GPP pathloss/shadowing model [Reference 81] and assumes a carrier frequency of 900 MHz. The dots in the map indicate the location of the DIDO-BTSs, whereas the dark circle represents the user-cluster (with the UE being located at the center of the circle). In sparsely populated areas 1201, the UE sees only a few BTSs within its user-cluster (e.g., as low as three BTSs for the example in FIG. 12), whereas in densely populated areas 1202 each user-cluster may comprise as many as 26 BTSs as in FIG. 12.

The high redundancy of the CRS can be exploited in MU-MASs to enable CSI estimation from any number of transmit antennas greater than four. For example, if the channel is fixed-wireless or characterized by low Doppler effects, there is no need to compute the CSI from all four transmit antennas every 0.5 msec (slot duration). Likewise, if the channel is frequency-flat, estimating the CSI every sixth subcarrier is redundant. In that case, the resource elements (RE) occupied by the redundant CRS can be re-allocated for other transmit antennas or BTSs in the MU-MAS. In one embodiment of the invention, the system allocates resource elements of redundant CRS to extra antennas or BTSs in the MU-MAS system. In another embodiment, the system estimates time and frequency selectivity of the channel and dynamically allocates the CRS for different BTSs or only the BTSs within the user-cluster to different resource elements.

The number of BTSs included in every user-cluster depends on the signal power level measured at the UE from all BTSs in the user-cluster relative to the noise power level, or signal-to-noise ratio (SNR). In one embodiment, the UE estimates the SNR from all BTSs in its neighborhood and selects the BTSs that belong to its user-cluster based on the SNR information. In another embodiment, the CP is aware of the SNR from the BTSs to every UE (based on feedback information from the UEs or information obtained from the UL channel, assuming UL/DL channel reciprocity) and selects the set of BTSs to be included in every user-cluster.

The number of BTSs included in every user-cluster determines the performance of the MU-MAS methods described in the present invention. For example, if the number of BTSs per user-cluster is low, the UE experiences higher level of out-of-cluster interference, resulting in high signal-to-interference-plus-noise ratio (SINR) and low data rate. Similarly, if large number of BTSs is selected for every user-cluster, the SNR measured at the UE from the BTSs at the edge of the user-cluster is low and may be dominated by the out-of-cluster interference from adjacent BTSs outside the user-cluster. There is an optimal number of BTSs per user-cluster that produces the highest SINR and data rate. In one embodiment of the invention, the CP selects the optimal number of BTSs per user-cluster to maximize SINR and data rate to the UE. In another embodiment of the invention, the BTSs per user-cluster are dynamically selected to adapt to the changing conditions of the propagation environment or UE mobility.

Another drawback of using large number of BTSs per user-cluster is high computational load. In fact, the more BTSs in the user-cluster the larger the computation complexity of the MU-MAS precoder. In one embodiment of the inventions, the BTSs per user-cluster are selected to achieve optimal tradeoff between SINR or data rate performance and computational complexity of the MU-MAS precoder. In another embodiment, the BTSs per user-cluster are dynamically selected based on tradeoffs between propagation conditions and computational resources available in the MU-MAS.

### 1.1.2 MU-MAS Signaling Using CSI-RS and DM-RS

In the LTE-Advanced (Release 10) standard the CSI-RS is used by every UE to estimate the CSI from the BTSs [References 33,83]. The standard defines orthogonal CSI-RS for different transmitters at the BTS, so that the UE can differentiate the CSI from different BTSs. Up to eight transmit antennas at the BTS are supported by the CSI-RS as in Tables 6.10.5.2-1,2 in [Reference 33]. The CSI-RS is sent with a periodicity that ranges between 5 and 80 subframes (i.e., CSI-RS send every 5 to 80 msec) as in Tables 6.10.5.3-1 in [Reference 33]. The periodicity of the CSI-RS in LTE-Advanced was designed intentionally larger than the CRS in LTE to avoid excessive overhead of control information, particularly for legacy LTE terminals unable to make use of these extra resources. Another reference signal used for CSI estimation is to demodulation RS (DM-RS). The DM-RS is a demodulation reference signal intended to a specific UE and transmitted only in the resource block assigned for transmission to that UE.

When more than eight antennas (maximum number of transmitters supported by the LTE-Advanced standard) are within the user-cluster, alternative techniques must be employed to enable DIDO precoding while maintaining system compliance to the LTE-Advanced standard. In one embodiment of the invention, every UE uses the CSI-RS or the DM-RS or combination of both to estimate the CSI from all active BTSs in its own user-cluster. In the same embodiment, the DIDO system detects the number of BTSs within the user-cluster and whether or not the user-cluster is compliant to the LTE-Advanced standard (supporting at most eight antennas). If it not compliant, the DIDO system employs alternative techniques to enable DL signaling from the BTSs to the current UE. In one embodiment, the transmit power from the BTSs is reduced until at most eight BTSs are reachable by the UE within its user-cluster. This solution, however, may result in reduction of data rate as coverage would be reduced.

Another solution is to divide the BTSs in the user-cluster in subsets and send one set of CSI-RS for every subset at a time. For example, if the CSI-RS periodicity is 5 subframes (i.e., 5 msec) as in Table 6.10.5.3-1 in [Reference 33], every 5 msec the CSI-RS is sent from a new subset of BTSs. Note that this solution works as long as the CSI-RS periodicity is short enough to cover all BTS subsets within the channel coherence time of the UE (which is a function of the Doppler velocity of the UE). For example, if the selected CSI-RS periodicity is 5 msec and the channel coherence time is 100 msec, it is possible to define up to 20 BTS subsets of 8 BTS each, adding up to a total of 160 BTSs within the user-cluster. In another embodiment of the invention, the DIDO system estimates the channel coherence time of the UE and decides how many BTSs can be supported within the user-cluster for given CSI-RS periodicity, to avoid degradation due to channel variations and Doppler effect.

The solutions for CSI-RS proposed so far are all compliant with the LTE standard and can be deployed within the framework of conventional LTE systems. For example, the proposed method that allows more than eight antennas per user-cluster would not require modifications of the UE LTE hardware and software implementation, and only slight modification of the protocols used at the BTSs and CP to enable selection of BTSs subset at any given time. These modifications can be easily implemented in a cloud-based software defined radio (SDR) platform, which is one promising deployment paradigm for DIDO and MU-MAS systems. Alternatively, if it is possible to relax the constraints of the LTE standard and develop slightly modified hardware and software for LTE UEs to support similar, but non-LTE-compliant DIDO or MU-MAS modes of operation, so as enable UEs to be able to operate in full LTE-compliant mode, or in a modified mode that supports non-LTE-compliant DIDO or MU-MAS operation. For example, this would enable another solution is to increase the amount of CSI-RS to enable higher number of BTSs in the system. In another embodiment of the invention, different CSI-RS patterns and periodicities are allowed as a means to increase the number of supported BTSs per user-cluster. Such slight modifications to the LTE standard may be small enough that existing LTE UE chipsets can be used with simply software modification. Or, if hardware modification would be needed to the chipsets, the changes would be small.

1.2 Uplink MU-MAS CSI Feedback Methods within the LTE Standard

In the LTE and LTE-Advanced standards, the UE feedbacks information to the BTS to communicate its current channel conditions as well as the precoding weights for closed-loop transmission over the DL channel. Three different channel indicators are included in those standards [Reference 35]:
Rank indicator (RI): indicates how many spatial streams are transmitted to given UE. This number is always equal or less than the number of transmit antennas.
Precoding matrix indicator (PMI): is the index of the codebook used for precoding over the DL channel.
Channel quality indicator (CQI): defines the modulation and forward error correction (FEC) coding scheme to be used over the DL to maintain predefined error rate performance for given channel conditions

Only one RI is reported for the whole bandwidth, whereas the PMI and CQI reporting can be wideband or per sub-band, depending on the frequency-selectivity of the channel. These indicators are transmitted in the UL over two different types of physical channels: i) the physical uplink control channel (PUCCH), used only for control information; ii) the physical uplink shared channel (PUSCH), used for both data and control information, allocated over one resource block (RB) and on a sub-frame basis. On the PUCCH, the procedure to report the RI, PMI and CQI is periodic and the indicators can be either wideband (for frequency-flat channels) or UE-selected on a sub-band basis (for frequency-selective channels). On the PUSCH, the feedback procedure is aperiodic and can be UE-selected on a sub-band basis (for frequency-selective channels) or higher-layer configured sub-band (e.g., for transmission mode 9 in LTE-Advance with eight transmitters).

In one embodiment of the invention, the DIDO or MU-MAS system employs RI, PMI and CQI to report to BTSs and CP its current channel conditions as well as precoding information. In one embodiment, the UE uses the PUCCH channel to report those indicators to the CP. In another embodiment, in case a larger number of indicators is necessary for DIDO precoding, the UE employs the PUSCH to report additional indicators to the CP. In case the channel is frequency-flat, the UE can exploit extra UL resources to report the PMI for a larger number of antennas in the DIDO systems. In one embodiment of the invention, the UE or BTSs or CP estimate the channel frequency selectivity and, in case the channel is frequency-flat, the UE exploits the extra UL resources to report the PMI for larger number of BTSs.

### 2. Downlink Open-Loop MU-MAS Precoding Methods in LTE

Open-loop MU-MAS precoding schemes can only be used in time-division duplex (TDD) systems employing RF calibration and exploiting channel reciprocity. The general mechanism of open-loop schemes in MU-MASs consists of: i) the UEs send signaling information to the BTSs or CTRs over the UL; ii) the BTSs or CTRs exploit that signaling information to estimate the UL CSI from all UEs; iii) the BTSs or CTRs employ RF calibration to convert the UL CSI into DL CSI; iv) the BTSs or CTRs send the DL CSI or codebook index to the CP via the BSN; v) based on that DL CSI, the CP calculates the precoding weights for data transmission over the DL. Similarly to closed-loop MU-MAS precoding schemes, user-clusters can be employed to reduce the amount of CSI to be estimated at the BTSs from the UEs, thereby reducing the computational burden at the BTSs as well as the amount of signaling required over the UL. In one embodiment of the invention, open-loop precoding techniques are employed to send simultaneous non-interfering data streams from the BTSs to the UEs over the DL channel.

In LTE there are two types of reference signal for the uplink channel [References 31,33,87]: i) sounding reference signal (SRS), used for scheduling and link adaptation; ii) demodulation reference signal (DMRS), used for data reception. In one embodiment of the invention, the DMRS is employed in open-loop precoding systems to estimate the UL channels form all UEs to all BTSs. In the time domain, the DMRS is sent at the fourth OFDM symbol (when a normal cyclic prefix is used) of every LTE slot (of duration 0.5 msec). In the frequency domain, the DMRS sent over the PUSCH is mapped for every UE to the same resource block (RB) used by that UE for UL data transmission. The length of the DMRS is M^{RS}=mN^{RB}, where m is the number of RBs and N^{RB}=12 is the number of subcarriers per RB. To support multiple UEs, up to twelve DMRSs are generated from one base Zadoff-Chu [Reference 88] or computer-generated constant amplitude zero autocorrelation (CG-CAZAC) sequence, via twelve possible cyclic shifts of the base sequence. Base sequences are divided into 30 groups and neighbor LTE cells select DMRS from different groups to reduce inter-cell interference. For example, if the maximum number of resource blocks within one OFDM symbol is 110 (i.e., assuming 20 MHz overall signal bandwidth), it is possible to generate up to 110×30=3300 different sequences. We observe that the 30 base sequences are not guaranteed to be orthogonal and are designed to reduce interference across cells, without eliminating it completely. By contrast, the 12 cyclic shifts of the same base sequence are orthogonal, thereby allowing up to 12 UEs to transmit in the UL over the same RB without interference. The value of cyclic shift to be used by every UE is provided by the BTS through the downlink control information (DCI) message sent over the PDCCH. The DCI in Release 8 consists of 3 bits, that enables the UE to use only up to 8 values of cyclic shift in the pool of twelve possible options.

The cyclic shifts of the base DMRS sequence are exploited in the present invention to enable MU-MIMO schemes over the UL channel as well as to estimate the CSI from multiple UEs for DL precoding when channel reciprocity is exploited in TDD mode. In one embodiment of the invention, open-loop precoding methods are employed to send simultaneous non-interfering data streams from the distributed BTSs to the UEs over the DL channel. In a different embodiment of the invention, open-loop MU-MIMO methods are employed to receive simultaneous non-interfering data streams from the UEs to the BTSs over the UL channel. The same CSI estimated over the UL from all active UEs can be used to compute the receiver spatial filter for MU-MIMO operation in the UL as well as the weights for DL precoding. Since Release 8 defines only up to 8 orthogonal DMRSs (due to limited DCI bits, as explained above), MU-MIMO schemes for the UL channel and MU-MAS precoding schemes for the DL channel can support at most eight UEs, assuming all UEs utilize the full UL bandwidth.

One way to increase the number of simultaneous UEs being served through MU-MIMO in UL or MU-MAS precoding in DL is to multiplex the DMRS of the UEs over the frequency domain. For example, if 10 MHz bandwidth is used in TDD mode, there are 50 RBs that can be allocated to the UEs. In this case, 25 interleaved RBs can be assigned to one set of eight UEs and the remaining 25 interleaved RBs to another set of UEs, totaling to 16 UEs that can be served simultaneously. Then, the CSI is computed by interpolating the estimates from the DMRS sent over interleaved RBs. Larger number of simultaneous UEs can be supported by increasing the number of interleaving patterns of the UL RBs. These patterns can be assigned to different UEs statically or dynamically according to certain frequency hopping sequence. In one embodiment of the invention, DMRSs are assigned to the UEs over orthogonal interleaved RBs to increase the number of UEs to be supported via MU-MIMO or MU-MAS precoding. In the same embodiment, the interleaved RBs are assigned statically. In another embodiment, the interleaved RBs are assigned dynamically according to certain frequency hopping pattern.

An alternative solution is to multiplex the DMRS of different UEs in the time domain. For example, the UEs are divided into different groups and the DMRSs for those groups are sent over consecutive time slots (of duration 0.5 msec each). In this case, however, it is necessary to guarantee that the periodicity of the DMRS assignment for different groups is lower than the channel coherence time of the fastest moving UE. In fact, this is necessary condition to guarantee that the channel does not vary for all UEs from the time the CSI is estimated via DMRS to the time system transmits DL data streams to the UEs via DIDO precoding. In one embodiment of the invention, the system divides the active UEs into groups and assigns the same set of DMRS to each group over consecutive time slots. In the same embodiment, the system estimates the shortest channel coherence time for all active UEs and calculates the maximum number of UE groups as well as the periodicity of the DMRS time multiplexing based on that information.

Another solution is to spatially separate different groups of UEs employing the same sets of DMRSs. For example, the same set of orthogonal DMRSs can be used for all the UEs from different antenna-subclusters in FIG. 11 identified by the same cell ID. In one embodiment of the invention, groups of UEs employing the same set of orthogonal DMRSs are spatially separated to avoid interference between the groups. In the same embodiment, the same set of orthogonal DMRSs is employed by different antenna-subclusters identified by the same cell ID. The MU-MAS may assign the UEs to “virtual cells” to maximize the number of DMRS that can be used in the UL. In one exemplary embodiment, the virtual cell is the area of coherence (described in related co-pending U.S. application Ser. No. 13/232,996, entitled “Systems and Methods to Exploit Areas of Coherence in Wireless Systems”) around the UE and the DIDO system generates up to 3300 areas of coherence for different UEs. In another embodiment of the invention, each of the 30 base sequences is assigned to a different antenna-cluster (clusters are defined in related U.S. Pat. No. 8,170,081, issued May 1, 2012, entitled “System And Method For Adjusting DIDO Interference Cancellation Based On Signal Strength Measurements”) to reduce inter-cluster interference across adjacent antenna-clusters.

### 3. Uplink MU-MAS Methods in LTE

The present invention employs open-loop MU-MIMO schemes over the UL channel to receive simultaneous UL data streams from all UEs to the BTSs. The UL open-loop MU-MIMO scheme consists of the following steps: i) UEs send signaling information and data payload to all BTSs; ii) the BTSs compute the channel estimations from all UEs using the signaling information; iii) the BTSs send the channel estimates and data payloads to the CP; iv) the CP uses the channel estimates to remove inter-channel interference from all UEs' data payloads via spatial filtering and demodulates the data streams form all UEs. In one embodiment, the open-loop MU-MIMO system employs single-carrier frequency division multiple access (SC-FDMA) to increase the number of UL channels from the UEs to the BTSs and multiplex them in the frequency domain.

In one embodiment, synchronization among UEs is achieved via signaling from the DL and all BTSs are assumed locked to the same time/frequency reference clock, either via direct wiring to the same clock or sharing a common time/frequency reference, in one embodiment through GPSDO. Variations in channel delay spread at different UEs may generate jitter among the time references of different UEs that may affect the performance of MU-MIMO methods over the UL. In one embodiment, only the UEs within the same antenna-cluster (e.g., UEs in close proximity with one another) are processed with MU-MIMO methods to reduce the relative propagation delay spread across different UEs. In another embodiment, the relative propagation delays between UEs are compensated at the UEs or at the BTSs to guarantee simultaneous reception of data payloads from different UEs at the BTSs.

The methods for enabling signaling information for data demodulation over the UL are the same methods used for signaling in the downlink open-loop DIDO scheme described at the previous section. The CP employs different spatial processing techniques to remove inter-channel interference from the UEs data payload. In one embodiment of the invention, the CP employs non-linear spatial processing methods such as maximum likelihood (ML), decision feedback equalization (DFE) or successive interference cancellation (SIC) receivers. In another embodiment the CP employs linear filters such as zeros-forcing (ZF) or minimum mean squared error (MMSE) receivers to cancel co-channel interference and demodulate the uplink data streams individually.

4. Integration with Existing LTE Networks

In the United States and other regions of the world, LTE networks are already in operation or are in the process of being deployed and/or committed to be deployed. It would be of significant benefit to LTE operators if they could gradually deploy DIDO or MU-MAS capability into their existing or already-committed deployments. In this way, they could deploy DIDO or MU-MAS in areas where it would provide the most immediate benefit, and gradually expand the DIDO or MU-MAS capability to cover more their network. In time, once they have sufficient DIDO or MU-MAS coverage in an area, they can choose to cease using cells entirely, and instead switch entirely to DIDO or MU-MAS and achieve much higher spectral density at much lower cost. Throughout this entire transition from cellular to DIDO or MU-MAS, the LTE operator's wireless customers will never see a loss in service. Rather, they'll simply see their data throughput and reliability improve, while the operator will see its costs decline.

There are several embodiments that would enable a gradual integration of DIDO or MU-MAS into existing LTE networks. In all cases, the BTSs for DIDO or MU-MAS will be referred as DIDO-LTE BTSs and will utilize one of the LTE-compatible DIDO or MU-MAS embodiments described above, or other LTE-compatible embodiments as they may be developed in the future. Or, the DIDO-LTE BTSs will utilize a slight variant of the LTE standard, such as those described above and the UEs will either be updated (e.g. if a software update is sufficient to modify the UE to be DIDO or MU-MAS compatible), or a new generation of UEs that are DIDO- or MU-MAS-compatible will be deployed. In either case, the new BTSs that support DIDO or MU-MAS either within the constraints of the LTE standard, or as a variant of the LTE standard will be referred to below as DIDO-LTE BTSs.

The LTE standard supports various channel bandwidths (e.g., 1.4, 3, 5, 10, 15 and 20 MHz). In one embodiment, an operator with an existing LTE network would either allocate new bandwidth for the LTE-DIDO BTSs, or would subdivide the existing LTE spectrum (e.g. 20 MHz could be subdivided into two 10 MHz blocks) to support conventional LTE BTSs in a cellular configuration in one block of spectrum and DIDO LTE BTSs in another block of spectrum. Effectively, this would establish two separate LTE networks, and UE devices would be configured to use one or the other network, or select between the two. In the case of subdivided spectrum, the spectrum could be divided evenly between the conventional LTE network and the DIDO-LTE BTS network, or unevenly, allocated more spectrum to whichever network could best utilize it given the level of cellular LTE BTS and DIDO-LTE BTS deployment and/or UE usage patterns. This subdivision could change as needed over time, and at some point, when there are sufficient DIDO-LTE BTSs deployed to provide the same or better coverage as the cellular BTSs, all of the spectrum can be allocated to DIDO-LTE BTSs, and the cellular BTSs can be decommissioned.

In another embodiment, the conventional cellular LTE BTSs can be configured to be coordinated with the DIDO-LTE BTSs such that they share the same spectrum, but take turns using the spectrum. For example, if they were sharing the spectrum use equally, then each BTS network would utilize one 10 ms frame time in alternation, e.g. one 10 ms frame for the cellular LTE BTS, followed by one 10 ms frame for the DIDO-LTE BTS. The frame times could be subdivided in unequal intervals as well. This interval splitting could change as needed over time, and at some point, when there are sufficient DIDO-LTE BTSs deployed to provide the same or better coverage as the cellular BTSs, all of the time can be allocated to DIDO-LTE BTSs, and the cellular BTSs can be decommissioned.

In another embodiment of the invention, DIDO or MU-MAS is employed as LOS or NLOS wireless backhaul to small cells in LTE and LTE-Advanced networks. As small-cells are deployed in LTE networks, DIDO or MU-MAS provides high-speed wireless backhaul to those small cells. As the demand for higher data rate increases, more small-cells are added to the network until the wireless network reaches a limit where no more small-cells can be added in a given area without causing inter-cell interference. In the same embodiment of the invention, DIDO-LTE BTSs are used to replace gradually small-cells, thereby exploiting inter-cell interference to provide increased network capacity.

### 5. MU-MAS LTE Scheduler

In MU-MAS, distributed antennas or BTSs transmit simultaneous precoded data streams to multiple UEs. As described in Related Patents and Applications, the number of BTSs must be equal or larger than the number of UEs to enable simultaneous data transmissions. In practical deployments, the number of UEs may exceed the number of BTSs. In this case, the extra UEs can be selected for transmission at different time slots or frequency bands according to certain scheduling policy. The scheduler exploits the channel quality information of the UEs to decide the best set of UEs to be serviced at a give time and frequency. Different scheduling methods are used in the present invention, including proportional fair scheduler, round-robin or greedy algorithms.

As described in the previous sections, the LTE standard defines two parameters to inform the scheduler about the link quality of every UE: CQI and SRS. The CQI measures the quality of the DL channel and is fed back from the UE to the BTS. The SRS is signaling information sent from the UE to the BTS to measure the UL channel quality. Both indicators provide information of the UL/DL channel quality over time and frequency domains. In FDD systems, the DL scheduler must use the CQI as performance measure, since the DL and UL channel quality may vary due to different carrier frequencies. In TDD mode, the DL schedule employs either the CSI or the SRS or combination of both to perform its scheduling decision. The same performance metrics can be used for UL scheduling. In one embodiment of the invention, the MU-MAS scheduler employs the CQI and SRS as performance metrics used by the scheduling algorithm.

The MU-MAS described in the present invention enables one additional channel quality indicator not disclosed in prior art: the spatial selectivity indicator (SSI), described in related U.S. application Ser. No. 13/475,598, entitled “Systems and Methods to enhance spatial diversity in distributed-input distributed-output wireless systems”. The SSI can be computed based on the CSI obtained from all UEs via feedback mechanisms or from the UL channel (applying UL/DL channel reciprocity). In one embodiment of the invention, the scheduler employs the SSI as performance metric. The SSI is a measure of the spatial diversity available in the wireless link. The SSI depends on the spatial characteristics of the BTSs as well as the UEs. In one exemplary embodiment of the invention, the scheduler obtains the SSI from all the UEs and schedules the UEs with the “optimal” SSI according to certain scheduling criterion. If more BTSs are available than the active BTSs, the users selection criterion described above is combined with the antenna selection method described in related U.S. application Ser. No. 13/475,598, entitled “Systems and Methods to enhance spatial diversity in distributed-input distributed-output wireless systems”. In one embodiment of the invention, the scheduler selects the optimal subset of BTSs and UEs based on certain scheduling criterion.

With respect to FIGS. 9, 10 and 11, in certain scenarios there may not be enough orthogonal signaling sequences to enable large number of BTSs within the same antenna-cluster or antenna-subcluster. In this case, some level of interference may occur if additional BTSs are activated to cover regions with larger numbers of active UEs. In one embodiment of the invention, the scheduler measures the level of interference between antenna-clusters or antenna-subclusters and schedules the UEs to minimize the effect of that interference over the wireless link.

The antenna selection algorithm described in related U.S. application Ser. No. 13/475,598, entitled “Systems and Methods to enhance spatial diversity in distributed-input distributed-output wireless systems” is employed in the present invention to select the optimal set of active BTSs based on the SSI. This antenna selection algorithm, however, may require high computational complexity as MU-MAS precoding processing must be applied over all possible permutations of antenna subsets before making a decision on the best subset based on the SSI performance metric. In MU-MAS with large number of cooperative BTSs, this computational burden may become expensive or untenable to achieve in practical deployments. It is thus desirable to develop alternative techniques to reduce the number of antenna subsets while maintaining good performance of the antenna selection method. In one embodiment of the invention, the MU-MAS employs methods based on queuing of the antenna subset ID numbers, hereafter referred to as “antenna shuffling method”. In one embodiment of the invention, the antenna shuffling method subdivides the queue containing all possible antenna subset IDs (i.e., all possible permutations of active BTSs for given set of available BTSs) into different groups and assigns different priorities to those groups. These groups are defined to assign fair chances to all subset IDs to be selected, but the SSI metric is computed only for limited number of subsets (e.g., those ones with highest priority) thereby reducing computational complexity. In one exemplary embodiment, the queue of subset ID is divided into three groups where each group is assigned a different rule: i) group #1 contains the IDs with highest priority which are pulled out of the group only in case a new subset with higher priority is identified; ii) group #2 where new antenna subsets (selected from group #3) are included at every iteration of the method; iii) group #3 where the antenna subset IDs are shuffled according to round-robin policy. All subset IDs within group #1 and #2 are sorted at each iteration of the method based on their priority to give opportunity to subsets IDs from group #2 to be upgraded to group #1. The SSI is computed only for the subsets within groups #1 and #2 and the antenna selection algorithm is applied only to those subsets.

### 6. MU-MAS LTE User Equipment

The present invention comprises of different designs of the LTE UE. In one embodiment, the UE is an LTE UE that is compatible with the MU-MAS employing precoding as described above and depicted in FIG. 13.

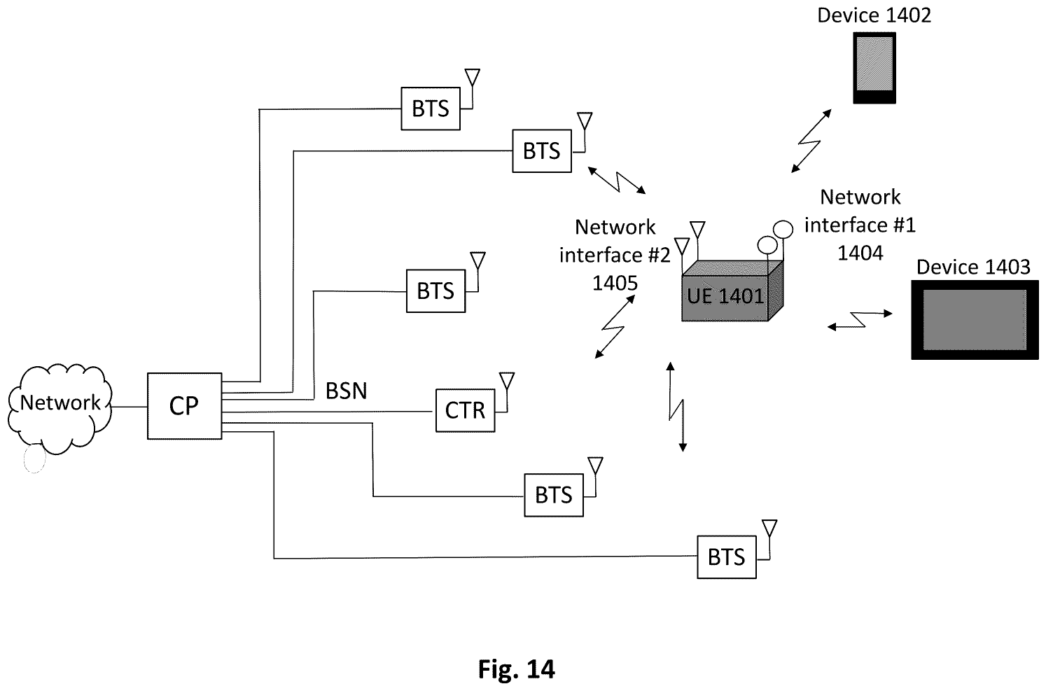

In a different embodiment, the UE 1401 connects to different devices 1402 and 1403 through a first network interface 1404 (e.g., Wi-Fi, USB, Ethernet, Bluetooth, optical fiber, etc.) and to the MU-MAS through a second network interface 1405 as shown in FIG. 14. The UE in FIG. 14 is equipped with two different network interfaces wherein each network interface comprises of one or multiple antennas (although in alternative embodiments, first network interface 1404 may be a wired interface without antennas). The antennas of the first network interface are denoted with circles, whereas the antennas of the second network interface are denoted with triangles. In the same embodiment, the second network interface supports MU-MAS precoding, MU-MAS implemented with LTE-compliant protocols, or MU-MAS (implemented with or without LTE-compliant protocols) and an alternative network. In the same embodiment, the alternative network is a cellular network, an LTE network or Wi-Fi network. In the same embodiment, the UE works with either and/or both MU-MAS and/or the alternative network and the UE selects either MU-MAS or the alternative network based on some criteria. In the same embodiment, the criteria are: i) whether only one network is available and is chosen; ii) whether one network has better performance; iii) whether one network is more economical; iv) whether one network is less congested; v) whether one network uses less UE resources.

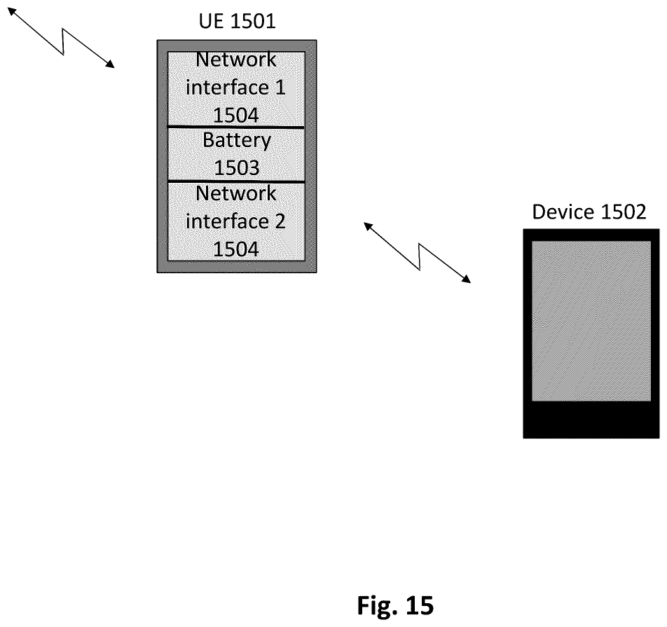

In one embodiment of the invention, the UE 1501 is in a case that physically attaches to the user device 1502 as depicted in FIG. 15. In the same embodiment, the case serves as a decorative addition to the user device. In another embodiment, the case serves to protect the user device from physical damage. The UE comprises of battery 1503, and one or multiple network interfaces 1504.

In one embodiment, the UE electronics are embedded within a case. In the same embodiment, the UE electronics include a battery 1503. The battery includes a power charger coupling through a physical electrical contact or a wireless contact. Exemplary power couplings are conductive, inductive, RF, light, or thermal, but power couplings are not limited these approaches. In the same embodiment, the UE electronics are coupled to receive power from the user device. This power coupling is through a physical contact or through an inductive or wireless contact. In the same embodiment, the user device is coupled to receive power from the MU-MAS UE. This coupling is through a physical contact or through an inductive or wireless contact. In a different embodiment, the same power charger powers both the user device and the MU_MAS UE.

In one embodiment of the invention, the UE is configured to communicate to the user device. In the same embodiment, the UE can be reset (e.g., via switch, or by removing power) so the user device can initially connect to it, and once the connection is established, the UE can be configured by the user device. Such configuration includes configuring a private password and/or other security protocols. In a different embodiment, the UE includes a means to be configured to communicate with the user device. Such configuration is done via a communications port to another device, wherein the communications port is USB, or via controls and/or buttons on the UE, or via display, wherein buttons or touch input are used.

In another embodiment, the same RF chain is used for MU-MAS communications as well as for the alternative network. In another embodiment, a different RF chain is used for MU-MAS communications and the alternative network.

### 7. Radio Frequency (RF) Calibration Exploiting Channel Reciprocity

Conventional closed-loop MU-MAS methods employ UL channel to feedback quantized CSI or codebook indices (as in codebook-based limited feedback schemes) from the UEs to the BTSs or CP. This scheme, however, results in large feedback overhead and high protocol complexity to enable the CSI feedback channel. In TDD systems, where UL and DL are set at the same frequency, it is thus desirable to avoid CSI feedback by exploiting UL/DL channel reciprocity. In practical systems, transmit and receive RF chains at the BTS or UE typically have different characteristics due to different RF components and circuit layout. Therefore, to preserve UL/DL reciprocity it is necessary to employ RF calibration methods to compensate for RF mismatch between transmit and receive chains.

Models for RF mismatch in typical wireless transceivers were described in [Reference 91] and hardware solutions to mitigate the effect of RF mismatch on the performance of adaptive digital beamforming systems were discussed in [Reference 92]. Software techniques to enable RF calibration in multiple-input multiple-output (MIMO) systems where proposed in [References 93,94] and experimental results for multiple-input single-output (MISO) and for systems employing antenna selection where shown in [Reference 95] and [Reference 96], respectively.

Prior art, however, assumes all RF chains are collocated on the same circuit board as in MIMO systems, thereby simplifying the RF calibration problem since information about the RF mismatch between all the RF chains is available locally. By contrast, the present invention consists of distributed antennas geographically placed far apart such that communication between those antennas only happens through the network. Hence, we define a novel system unit that we call “beacon station” designed specifically to enable RF calibration in MU-MASs with distributed antennas. Moreover, in prior art MIMO systems significant RF coupling between transmit/receive chains occurs due to the close proximity of the RF chains on the same board. By contrast, in the present invention, RF coupling occurs only between one transmit and one receive chain of the same distributed antenna. Hence, techniques employed for RF calibration are significantly different than the ones described in prior art as we will demonstrate hereafter. Finally, the RF calibration methods disclosed in prior art were limited to systems with a single user (e.g. a single User Equipment device). As shown in the derivations at the following paragraphs, systems with multiple users (e.g., MU-MASs) are particularly sensitive to RF mismatch, since that yields inter-user interference. As such, special techniques must be employed to enable RF calibration while exploiting channel reciprocity, as described below.

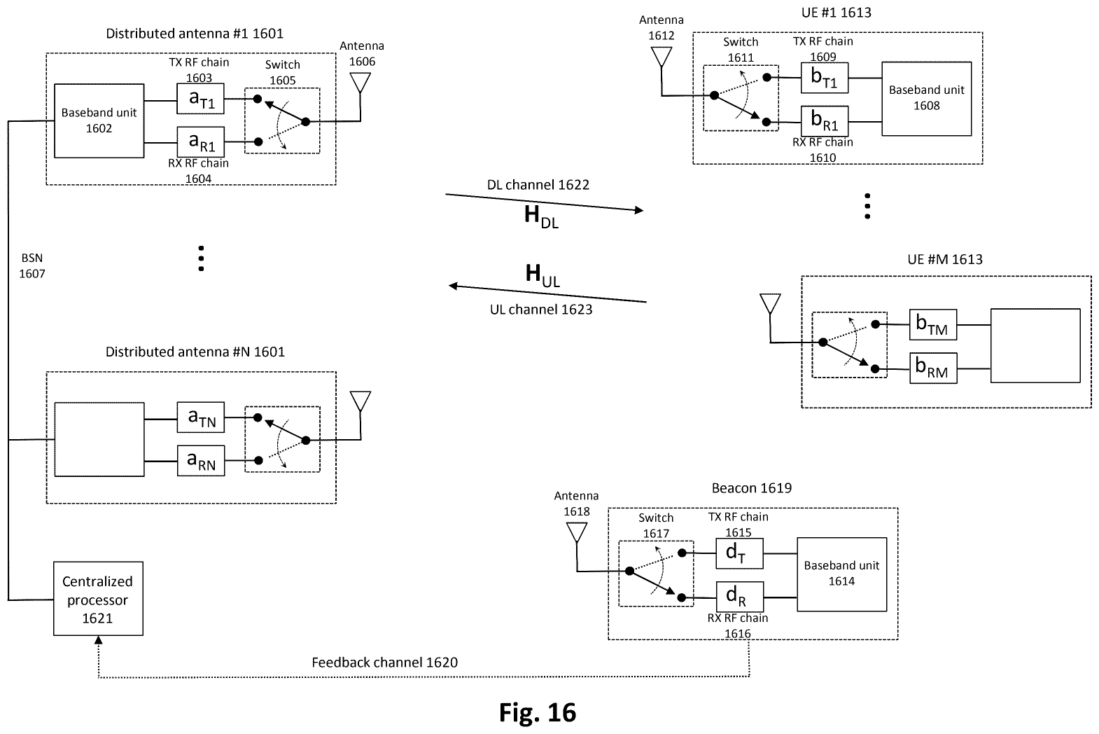

The present invention consists of a MU-MAS that employs radio frequency (RF) calibration and exploits reciprocity between downlink (DL) and uplink (UL) channels, comprising of multiple distributed antennas, multiple User Equipment devices (UEs) and one or multiple beacon stations. In one embodiment, the RF calibration is employed to compute the DL MU-MAS precoding weights from the UL channel estimates. FIG. 16 shows the block diagram of the system including the distributed antennas 1601, multiple UEs 1613, one beacon station 1619, one base station network (BSN) 1607 connecting the distributed antennas, one centralized processor (CP) 1621 and one feedback channel 1620, that is the calibration control channel from the beacon to the CP.

Every distributed antenna unit consists of baseband unit 1602, transmit RF chain 1603, receive RF chain 1604, RF switch unit 1605 that dynamically selects transmit/receive RF chains for TDD operation, and antenna 1606. In one embodiment, the baseband unit comprises baseband signal processing and digital-to-analog converter (DAC). In another embodiment, all the baseband processing is executed at the CP such that RF signal is sent to every distributed antenna (e.g., via RF coax cables or RF over fiber networks). Every UE consists of baseband unit 1608, transmit/receive RF chains 1609 and 1610, respectively, RF switch 1611 and antenna 1612. The beacon station is composed of baseband unit 1614, transmit/receive RF chains 1615 and 1616, respectively, RF switch 1617 and antenna 1618.

The wireless links between the distributed antennas and the UEs are modeled as complex Gaussian channel matrix H of dimensions M×N, where M is the number of UEs and N is the number of distributed antennas. We define H_{DL} the DL channel matrix 1622 and H_{UL} the UL channel matrix 1623. Channel reciprocity holds as long as DL and UL are set to the same carrier frequency. In this case, the following property holds

H_{DL}=H_{L}^{†=H}

where the symbol t denotes the transpose matrix operation.

The model above holds for either single-carrier or multicarrier systems. In multicarrier systems (e.g., OFDM) the complex matrix H represents the channel of one subcarrier, and the same model extends to any subcarrier in the system. FIG. 16 also shows transmit and receive RF units at the distributed antennas, modeled with complex channel matrices A_{T} and A_{R}, respectively, of dimension N×N. Likewise, the transmit and receive RF units at the UEs are modeled by the matrices B_{T} and B_{R}, respectively, of dimension M×M. In the case of MU-MAS with distributed antennas, RF coupling between distributed antennas and/or UEs is negligible due to relative antenna separation, such that A_{T}, A_{R}, B_{T} and B_{R} are represented as diagonal matrices. We observe this is a unique feature of MU-MAS with distributed antennas and distributed UEs. As such, the present invention is novel over prior art related to multiple-input multiple-output (MIMO) systems.

Based on the block diagram in FIG. 16, we write the effective DL channel matrix (modeling transmit/receive RF units and wireless links) as

H̅_{DL}=B_{R}H_{DL}A_{T}=B_{R}HA_{T}

and the effective UL channel matrix as

H̅_{UL}=A_{R}H_{UL}B_{T}=A_{R}H^{†}B_{T}

In the present invention, RF calibration is obtained by preconditioning the matrix of the UL channel estimates H_{UL} with the complex RF calibration matrix C, as follows

\tilde{H}_{DL}=(CH̅_{UL})^{†}

In one embodiment of the invention comprising LTE cellular networks, the effective UL channel is estimated at the eNodeB employing the DMRS from all UEs.

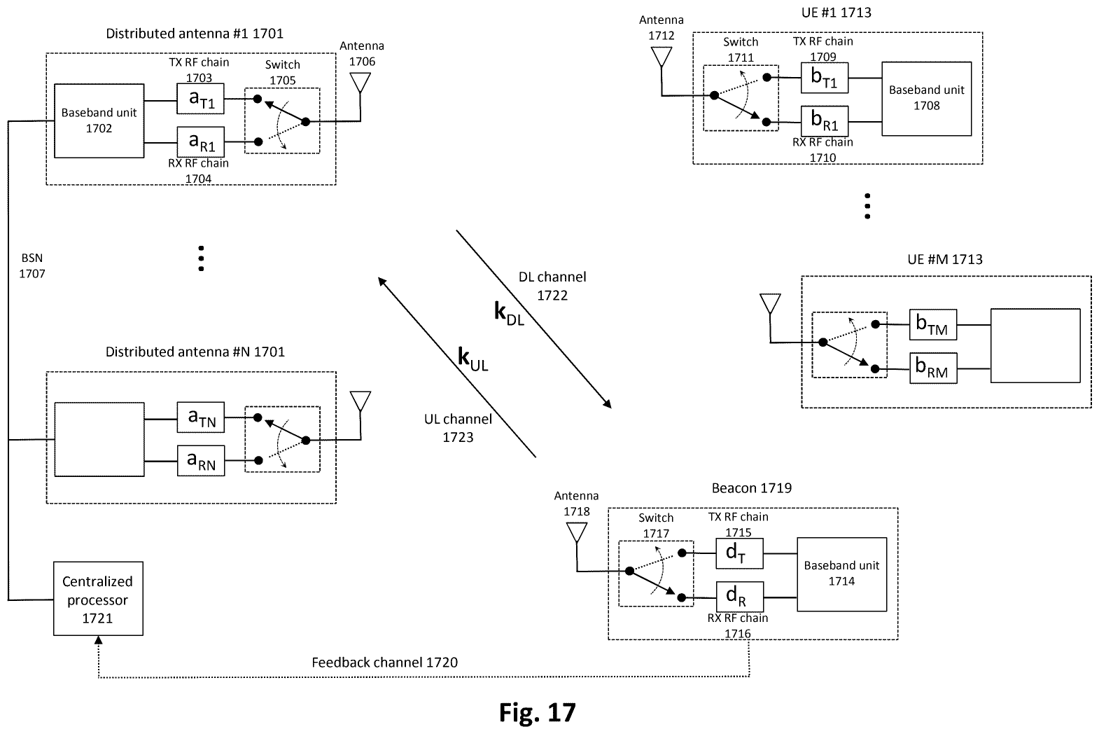

As shown in FIG. 17, the matrix C is computed from the effective DL (k̅_{DL}) channel 1722 and UL (k̅_{UL}) channel 1723 vectors between every distributed antenna 1701 and the beacon station 1719, defined as

k̅_{DL}=D_{R}k_{DL}A_{T}

and

k̅_{UL}=A_{R}k_{UL}D_{T}

where k_{DL}=k_{UL}=k are column vectors, assuming DL and UL channel reciprocity between the distributed antennas and the beacon station. In one embodiment, the DL channel between the distributed antennas and the beacon station is estimated by sending training signals from the distributed antennas to the beacon. In one exemplary embodiment comprising LTE cellular networks, the DL sequences CRS, or CSI-RS, or DM-RS are used by the beacon to estimate the effective DL channel from all eNodeBs. In the same embodiment, the UL channel between the beacon station and the distributed antennas is estimated by sending training signals from the beacon station to the antennas. In one embodiment of the invention, multiple beacon stations are employed to improve the estimation of the RF calibration matrix. In the present invention, there is no RF coupling between the distributed antennas, such that the RF calibration matrix C is diagonal.

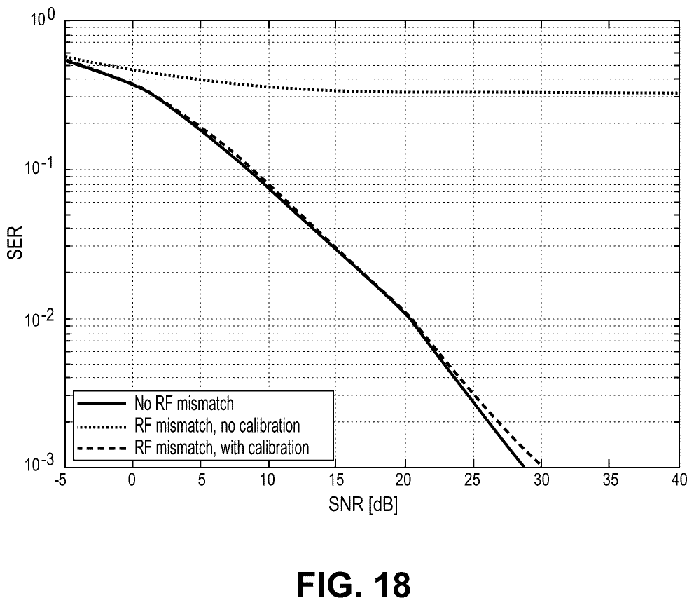

When linear precoding (e.g., zero-forcing [Reference 65], block-diagonalization or BD [66-67], matrix inversion, etc.) is employed, the symbol received at the m-th UE is given by

$${r}_{m} = {\overline{h}}_{D L , m} {\overline{w}}_{D L , m} {s}_{m} + {\sum }_{u = 1 , u \neq m}^{M} {\overline{h}}_{D L , m} {\overline{w}}_{D L , u} {s}_{u} + {n}_{m}$$

where h̅_{DL,m} is the m-th row of the effective channel matrix H̅_{DL}, w̅_{DL,m} is the precoding vector for the m-th UE derived from H̅_{DL}, Sₘ is the symbol transmitted to the m-th UE and nₘ is white Gaussian noise at the m-th UE. For the sake of simplicity, the above model assumes a single receive antenna at every UE, but the present invention extends to any number of antennas at the UE. It is possible to show that when the RF calibration method described above is employed the inter-client interference at every UE is pre-cancelled at the transmitter such that the following condition holds

$${\overline{h}}_{D L , m} {\overline{w}}_{D L , u} = {\overline{h}}_{D L , m} {\tilde{w}}_{D L , u} = 0 , ∀ u = 1 , … , M with u \neq m$$

where \tilde{w}_{DL,u} is the precoding weight vector derived from the RF calibrated channel matrix H_{DL}. In one embodiment, the precoding weights are computed from the RF calibrated channel matrix to pre-cancel inter-client interference at every UE. FIG. 18 shows the symbol error rate (SER) performance of MU-MAS employing BD precoding and 4-QAM modulation in frequency-flat channels for three scenarios: i) no RF mismatch; ii) RF mismatch without calibration; iii) RF mismatch with calibration. We observe the RF calibration method in the present invention reduces the SER down to ideal performance (i.e., with no RF mismatch).

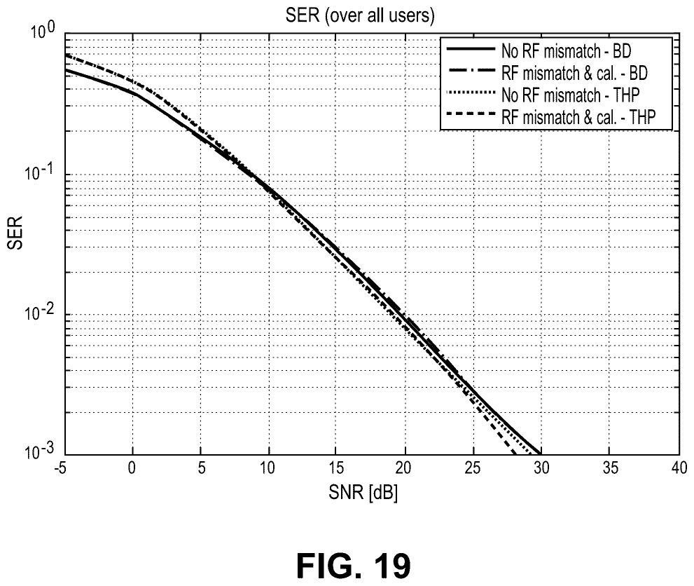

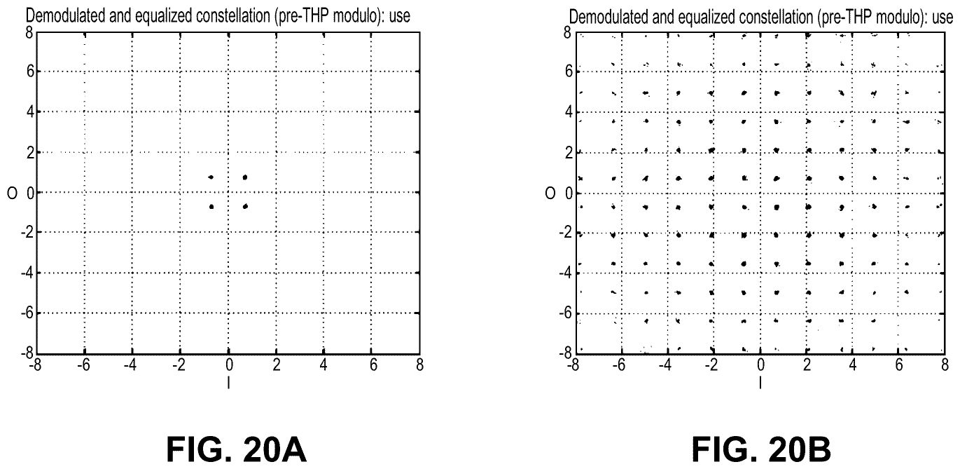

In another embodiment of the invention, non-linear precoding methods (e.g., dirty-paper coding [References 68-70] or Tomlinson-Harashima precoding or THP [References 71-72], lattice techniques or trellis precoding [References 73-74], vector perturbation techniques [References 75-76]) are applied to the RF calibrated channel matrix to pre-cancel inter-client interference at every UE. FIG. 19 shows that the SER obtained with non-linear precoding techniques using RF calibration and UL/DL reciprocity matches the performance of linear precoding. FIG. 20a shows the constellation before THP modulo operation for UE 1, whereas FIG. 20b shows the constellation before THP modulo operation for UE 2 (THP lattice structure) in MU-MAS with two distributed antennas and two UEs. THP precoding is designed to completely cancel interference to the “reference-UE” and applies successive interference cancellation schemes to the other UEs. As such it is expected the SER performance for the reference-UE may be better than the other UEs. In one embodiment, Round-Robin or proportional fair scheduling or other types of scheduling techniques are applied to the UEs to guarantee similar average SER performance to all UEs.

The computational performance of BD and THP methods may vary depending on the number of distributed antennas and/or UEs within every user-cluster. In one embodiment of the invention, the MU-MAS dynamically switches between linear and non-linear precoding techniques to minimize the computational complexity of the precoder, depending on the number of distributed antennas and/or UEs in every user-cluster.

In practical MU-MASs, the beacon station is a wireless transceiver dedicated to the use for RF calibration. Since the beacon requires feedback channel to communicate the estimated effective DL channel from all distributed antennas for calibration purposes, the beacon communicates to the CP via wireless or wireline link. In another embodiment, the beacon station is any of the distributed antennas, and the calibration parameters are computed with respect to that antenna. In the same embodiment, the distributed antennas are organized as in a mesh network and pair-wise RF calibration between adjacent distributed antennas is computed to guarantee good link quality. The RF calibration is carried across all antennas and calibration information is fed back to the CP such that all distributed antennas are calibrated with one another. In another embodiment, the beacon is any of the UEs that use any wireless or wireline link to feedback calibration information to the CP.

The calibration information from the beacon to the CP is quantized over limited number of bits or sent via codebook-based limited feedback methods to reduce overhead over the control channel. We observe that RF calibration can be run at a slow rate (depending on the rate of variation of the RF characteristics, due to temperature changes, etc.). If the rate of update of the calibration information is low, the wireless data channel can be used to send that information to the CP without causing any severe loss of data rate. In one exemplary embodiment, in LTE cellular networks the PUSCH is used to feedback calibration information from the UE to the CP.

One or multiple geographically distributed beacons are employed per user-cluster, or antenna-cluster or antenna-subcluster depending on the relative link quality between the beacon and the distributed antennas in that cluster. In one embodiment, the beacon with the best signal quality to all distributed antennas in the cluster is used for RF calibration. In another embodiment, the beacons are dynamically selected at every instance of time to adapt to the changing quality of the links to the distributed antennas due to variations in the propagation environment. In another embodiment, multiple beacons are employed cooperatively (e.g., via maximum ratio combining/transmission) to maximize the SNR or SINR over the links from/to the distributed antennas. In a different embodiment, one or more RF calibrations are carried out per cluster.

In one embodiment of the invention, the beacon station is used not only for RF calibration but also to send signaling information to the distributed antennas and/or UEs including time and frequency synchronization reference. The distributed antennas and/or UEs employ that reference to maintain time and frequency synchronization with the MU-MAS master reference clock. In one embodiment, this reference clock distribution from the beacon to the distributed antennas and UEs is enabled via the LTE multimedia broadcast single frequency network (MBSFN) communication channel.

### REFERENCES

[1] A. Paulraj, R. Nabar, and D. Gore, Introduction to Space-Time Wireless Communications, Cambridge University Press, 40 West 20th Street, New York, NY, USA, 2003
[2] D. Gesbert, M. Shafi, D. Shiu, P. J. Smith and A. Naguib, “From theory to practice: an overview of MIMO space-time coded wireless systems”, IEEE Journal on Selected Areas on Communications, vol. 2, n.3, pp. 281-302, April 2003
[3] L. Zheng and D. N. C. Tse, “Diversity and multiplexing: a fundamental tradeoff in multiple-antenna channels,” IEEE Trans. Info. Th., vol. 49, no. 5, pp. 1073-1096, May 2003
[4] D. N. C. Tse, P. Viswanath, and L. Zheng, “Diversity-multiplexing tradeoff in multiple-access channels”, IEEE Trans. Info. Th., vol. 50, no. 9, pp. 1859-1874, September 2004
[5] E. Visotsky and U. Madhow, “Space-time transmit precoding with imperfect feedback,” IEEE Trans. Info. Th., vol. 47, pp. 2632-2639, September 2001.
[6] S. A. Jafar, S. Vishwanath, and A. Goldsmith, “Channel capacity and beamforming for multiple transmit and receive antennas with covariance feedback,” Proc. IEEE Int. Conf. on Comm., vol. 7, pp. 2266-2270, June 2001.
[7] S. A. Jafar and A. Goldsmith, “Transmitter optimization and optimality of beamforming for multiple antenna systems,” IEEE Trans. Wireless Comm., vol. 3, pp. 1165-1175, July 2004.
[8] E. A. Jorswieck and H. Boche, “Channel capacity and capacity-range of beamforming in MIMO wireless systems under correlated fading with covariance feedback,” IEEE Trans. Wireless Comm., vol. 3, pp. 1543-1553, September 2004.
[9] A. L. Moustakas and S. H. Simon, “Optimizing multiple-input single-output (MISO) communication systems with general Gaussian channels: nontrivial covariance and nonzero mean,” IEEE Trans. Info. Th., vol. 49, pp. 2770-2780, October 2003.
[10] M. Kang and M. S. Alouini, “Water-filling capacity and beamforming performance of MIMO systems with covariance feedback,” IEEE Work. on Sign. Proc. Adv. in Wire. Comm., pp. 556-560, June 2003.
[11] S. H. Simon and A. L. Moustakas, “Optimizing MIMO antenna systems with channel covariance feedback,” IEEE Jour. Select. Areas in Comm., vol. 21, pp. 406-417, April 2003.
[12] S. M. Alamouti, “A simple transmit diversity technique for wireless communications,” IEEE Jour. Select. Areas in Comm., vol. 16, no. 8, pp. 1451-1458, October 1998.
[13] V. Tarokh, N. Seshadri, and A. R. Calderbank, “Space-time codes for high data rate wireless communication: Performance criterion and code construction,” IEEE Trans. Info. Th., vol. 44, pp. 744-65, March 1998.
[14] V. Tarokh, H. Jafarkhani, and A. R. Calderbank, “Space-time block codes from orthogonal designs,” IEEE Trans. Info. Th., vol. 45, pp. 1456-467, July 1999.
[15] E. N. Onggosanusi, A. G. Dabak, and T. A. Schmidl, “High rate space-time block coded scheme: performance and improvement in correlated fading channels,” Proc. IEEE Wireless Comm. and Net. Conf., vol. 1, pp. 194-199, March 2002.
[16] G. D. Durgin, Space-Time Wireless Channels, Prentice Hall, Upper Saddle River, NJ, USA, 2003
[17] D.-S. Shiu, G. J. Foschini, M. J. Gans, and J. M. Kahn, “Fading correlation and its effect on the capacity of multielement antenna systems,” IEEE Trans. Comm., vol. 48, no. 3, pp. 502-513, March 2000
[18] A. Forenza and R. W. Heath Jr., “Impact of antenna geometry on MIMO communication in indoor clustered channels,” Proc. IEEE Antennas and Prop. Symp., vol. 2, pp. 1700-1703, June 2004.
[19] E. A. Jorswieck and H. Boche, “Channel capacity and capacity-range of beamforming in MIMO wireless systems under correlated fading with covariance feedback,” IEEE Trans. Wireless Comm., vol. 3, pp. 1543-1553, September 2004
[20] R. W. Heath Jr. and A. Paulraj, “Switching between multiplexing and diversity based on constellation distance,” Proc. of Allerton Conf. on 208, Comm. Control and Comp., September 2000.
[21] S. Catreux, V. Erceg, D. Gesbert, and R. W. Heath Jr., “Adaptive modulation and MIMO coding for broadband wireless data networks,” IEEE Comm. Mag., vol. 2, pp. 108-115, June 2002.
[22] A. Forenza, A. Pandharipande, H. Kim, and R. W. Heath Jr., “Adaptive MIMO transmission scheme: Exploiting the spatial selectivity of wireless channels,” Proc. IEEE Veh. Technol. Conf., vol. 5, pp. 3188-3192, May 2005
[23] C. B. Chae, A. Forenza, R. W. Heath, Jr., M. R. McKay, and I. B. Collings, “Adaptive MIMO Transmission Techniques for Broadband Wireless Communication Systems,” IEEE Communications Magazine, vol. 48, no. 5, pp. 112-118, May 2010
[24] FCC, “Broadband action agenda”, National Broadband Plan, 2010 http://www.broadband.gov/plan/national-broadband-plan-action-agenda.pdf
[25], N. Delfas, F. Meunier, S. Flannery, T. Tsusaka, E. Gelblum and S. Kovler, “Mobile data wave: who dares to invest, wins”, Morgan Stanley Research Global, Jun. 13, 2012
[26] D. Goldman, “Sorry, America: your wireless airwaves are full”, CNN Money http://money.cnn.com/2012/02/21/technology/spectrum_crunch/index.htm
[27] P. Rysavy, “No silver bullets for FCC, NTIA spectrum challange”, Daily report for executives, Bloomberg BNA, August 2012 http://www.rysavy.com/Articles/2012_09_No_Spectrum_Silver_Bullets.pdf
[28] T. W. Hazlett, “Radio spectrum for a hungry wireless world”, Sep. 22, 2011
[29] B. J. Love, D. J. Love and J. V. Krogmeier, “Like deck chairs on the Titanic: why spectrum reallocation won't avert the coming data crunch but technology might keep the wireless industry afloat”, February 2012
[30] Qualcomm, “The 1000× data challenge, the latest on wireless, voice, services and chipset evolution”, 4G World, Oct. 31, 2012
[31] J. Lee, J.-K. Han, J. Zhang, “MIMO technologies in 3GPP LTE and LTE-advanced”, EURASIP Journal on Wireless Comm. and Net., Hindawi, May 2009
[32] 3GPP, TS 36.201, “Evolved Universal Terrestrial Radio Access (E-UTRA); LTE Physical Layer-General Description (Release 8)”
[33] 3GPP, TS 36.211, “Evolved Universal Terrestrial Radio Access (E-UTRA); Physical Channels and Modulation (Release 8)”
[34] 3GPP, TS 36.212, “Evolved Universal Terrestrial Radio Access (E-UTRA); Multiplexing and channel coding (Release 8)”
[35] 3GPP, TS 36.213, “Evolved Universal Terrestrial Radio Access (E-UTRA); Physical layer procedures (Release 8)”
[36] T. Yoo, N. Jindal, and A. Goldsmith, “Multi-antenna broadcast channels with limited feedback and user selection,” IEEE Journal on Sel. Areas in Communications, vol. 25, pp. 1478-91, July 2007.
[37] P. Ding, D. J. Love, and M. D. Zoltowski, “On the sum rate of channel subspace feedback for multi-antenna broadcast channels,” in Proc., IEEE Globecom, vol. 5, pp. 2699-2703, November 2005.
[38] N. Jindal, “MIMO broadcast channels with finite-rate feedback,” IEEE Trans. on Info. Theory, vol. 52, pp. 5045-60, November 2006.
[39] D. J. Love, R. W. Heath, Jr., V. K. N. Lau, D. Gesbert, B. D. Rao, and M. Andrews, “An Overview of Limited Feedback in Wireless Communication Systems,” IEEE Journal on Sel. Areas in Comm., Special Issue on Exploiting Limited Feedback in Tomorrow's Wireless Communication Networks, vol. 26, no. 8, pp. 1341-1365, October 2008.
R. W. Heath, Jr., D. J. Love, V. K. N. Lau, D. Gesbert, B. D. Rao, and M. Andrews, “Exploiting Limited Feedback in Tomorrow's Wireless Communication Networks,” IEEE Journal on Sel. Areas in Comm., Special Issue on Exploiting Limited Feedback in Tomorrow's Wireless Communication Networks, vol. 26, no. 8, pp. 1337-1340, October 2008.
[41] D. J. Love, R. W. Heath, Jr., and T. Strohmer, “Grassmannian Beamforming for Multiple-Input Multiple-Output Wireless Systems,” IEEE Trans. on Info. Theory special issue on MIMO Communication, vol. 49, pp. 2735-2747, October 2003
[42] C. B. Chae, D. Mazzarese, N. Jindal and R. W. Heath, Jr., “Coordinated Beamforming with Limited Feedback in the MIMO Broadcast Channel” IEEE Journal on Sel. Areas in Comm., Special Issue on Exploiting Limited Feedback in Tomorrow's Wireless Comm. Networks, vol. 26, no. 8, pp. 1505-1515, October 2008
[43] A. Paulraj, “Is OFDMA, MIMO and OS the right stuff for mobile broad-band?” http://www.ieeevtc.org/vtc2005fall/presentations/paulraj.pdf, September 2005
[44] J. Wannstrom, “Carrier aggregation explained”, 3GPP http://www.3gpp.org/Carrier-Aggregation-explained
[45] 3GPP, TS 36.808, “Evolved Universal Terrestrial Radio Access (E-UTRA); Carrier Aggregation (Release 10)”, v10.0.0, June 2012
[46] Nokia Siemens Networks, “2020: beyond 4G, radio evolution for the gigabit experience”, White Paper, 2011, www.nokiasiemensnetworks.com
[47] S. Marek, “AT&T's Rinne talks about carrier aggregation trials, small cells and more”, http://www.fiercebroadbandwireless.com/story/atts-rinne-talks-about-carrier-aggregation-trials-small-cells-and-more/2012-11-08
[48] M. Reed, “InterfereX”, Tech23, 2011 http://www.youtube.com/watch?v=YPpELm6iip8
[49] NICTA, “InterfereX”, http://www.nicta.com.au/research/archive/research_themes/networked_systems/interfe rex
[50] J. Duplicity, et al., “MU-MIMO in LTE systems”, EURASIP Journal on Wireless Communications and Netowrking, March 2011
[51] S. Feng and E. Seidel, “Self-organizing networks (SON) in 3GPP LTE”, Nomor research, May 2008
[52] NEC, “Self organizing networks”, White paper, February 2009
[53] U.S. Pat. No. 5,809,422, issued Sep. 15, 1998, entitled “Distributed microcellular communications system”, G. R. Raleigh, M. A. Pollack
[54] G. J. Foschini, H. C. Huang, K. Karakayali, R. A. Valenzuela, and S. Venkatesan. The Value of Coherent Base Station Coordination. In Conference on Information Sciences and Systems (CISS 2005), March 2005
[55] M. K. Karakayali, G. J. Foschini, R. A. Valenzuela, and R. D. Yates, “On the maximum common rate achievable in a coordinated network,” Proc. of the Int'l Conf. on Communications (ICC'06), vol. 9, pp. 4333-4338, June 2006.
[56] M. K. Karakayali, G. J. Foschini, and R. A. Valenzuela, “Network coordination for spectrally efficient communications in cellular systems,” IEEE Wireless Communications Magazine, vol. 13, no. 4, pp. 56-61, August 2006.
[57] G. J. Foschini, M. K. Karakayali, and R. A. Valenzuela, “Coordinating multiple antenna cellular networks to achieve enormous spectral efficiency,” Proceedings of the IEEE, vol. 153, no. 4, pp. 548-555, August 2006.
[58] S. Venkatesan, A. Lozano, and R. Valenzuela, “Network MIMO: overcoming inter-cell interference in indoor wireless systems”, Proc. of Asilomar conf., pp. 83-87, November 2007
[59] S. Venkatesan, H. Huang, A. Lozano, and R. Valenzuela, “A WiMAX-based implementation of network MIMO for indoor wireless systems”, EURASIP Journal on Advances in Signal Processing, September 2009
[60] Y. Liang, R. Valenzuela, G. Foschini, D. Chizhik, and A. Goldsmith, “Interference suppression in wireless cellular networks through picocells”, ACSSC, pp. 1041-1045, November 2007
[61] A. Papadogiannis, H. J. Bang, D. Gesbert, and E. Hardouin, “Efficient selective feedback design for multicell cooperative networks”, IEEE Trans. On Vehicular Techn., pp. 196-205, vol. 60, n.1, January 2011
[62] I. F. Akyildiz, D. M. Guterrez-Estevez, E. C. Reyes, “The evolution to 4G cellular systems: LTE-Advanced”, Physical Comm., Elsevier, pp. 217-244, 2010
[63] A. Barbieri, P. Gaal, S. Geirhofer, T. Ji, D. Malladi, Y. Wei, and F. Xue, “Coordinated downlink multi-point communications in heterogeneous cellular networks”, (Qualcomm), Information Theory and App. Workshop, pp. 7-16, February 2012
[64] S. Parkvall, E. Dahlman, A. Furuskar, Y. Jading, M. Olsson, S. Wanstedt, and K. Zangi, “LTE-Advanced-evolving LTE towards IMT-Advanced”, (Ericsson) IEEE VTC, pp. 1-5, September 2008
[65] R. A. Monziano and T. W. Miller, Introduction to Adaptive Arrays, New York: Wiley, 1980.
[66] K. K. Wong, R. D. Murch, and K. B. Letaief, “A joint channel diagonalization for multiuser MIMO antenna systems,” IEEE Trans. Wireless Comm., vol. 2, pp. 773-786, July 2003;
[67] R. Chen, R. W. Heath, Jr., and J. G. Andrews, “Transmit Selection Diversity for Unitary Precoded Multiuser Spatial Multiplexing Systems with Linear Receivers,” IEEE Trans. on Signal Proc., vol. 55, no. 3, pp. 1159-1171, March 2007.
[68] M. Costa, “Writing on dirty paper,” IEEE Transactions on Information Theory, Vol. 29, No. 3, Page(s): 439-441, May 1983.
[69] G. Caire and S. Shamai, “On the achievable throughput of a multiantenna Gaussian broadcast channel,” IEEE Trans. Info.Th., vol. 49, pp. 1691-1706, July 2003.
[70] N. Jindal & A. Goldsmith, “Dirty Paper Coding vs. TDMA for MIMO Broadcast Channels”, IEEE Trans. on Info. Theory, vol. 51, pp. 1783-1794, May 2005
[71] M. Tomlinson, “New automatic equalizer employing modulo arithmetic,” Electronics Letters, Page(s): 138-139, March 1971.
[72] H. Miyakawa and H. Harashima, “A method of code conversion for digital communication channels with intersymbol interference,” Trans. of the Inst. of Electronic
[73] U. Erez, S. Shamai (Shitz), and R. Zamir, “Capacity and lattice-strategies for cancelling known interference,” Proceedings of International Symposium on Information Theory, Honolulu, Hawaii, November 2000.
[74] W. Yu and J. M. Cioffi, “Trellis Precoding for the Broadcast Channel”, IEEE Globecom, vol. 2, pp. 1344-1348, 2001
[75] B. M. Hochwald, C. B. Peel, and A. L. Swindlehurst, “A Vector-Perturbation Technique for Near-Capacity Multiantenna Multiuser Communication-Part I: Channel Inversion and Regularization”, IEEE Trans. On Communications, vol. 53, n.1, pp. 195-202, January 2005
[76] B. M. Hochwald, C. B. Peel, and A. L. Swindlehurst, “A Vector-Perturbation Technique for Near-Capacity Multiantenna Multiuser Communication-Part II: Perturbation”, IEEE Trans. On Comm., vol. 53, n. 3, pp. 537-544, March 2005
[77] S. Perlman and A. Forenza, “Distributed-input distributed-output (DIDO) wireless technology: a new approach to multiuser wireless”, Rearden Labs White Paper, July 2011, http://www.reardenwireless.com/110727-DIDO-A %20New %20Approach %20to %20Multiuser %20Wireless.pdf
[78] A. Vance, “Steve Perlman's wireless fix”, Businessweek, July 2011 http://www.businessweek.com/magazine/the-edison-of-silicon-valley-07272011.html
[79] M. Lindstrôm (Ericsson), “LTE-Advanced Radio Layer 2 and RRC aspects”, 3GPP TSG-RAN WG2 [00260][80] Anritsu, “LTE resource guide”, www.us.anritsu.com
[81] 3GPP, “Spatial Channel Model AHG (Combined ad-hoc from 3GPP & 3GPP2)”, SCM Text V6.0, Apr. 22, 2003
[82] J. Lee, “Introduction of LTE-Advanced DL/UL MIMO”, Samsung Electronics, September 2009
[83] E. Dahlman, S. Parkvall and J. Skold, “4G: LTE/LTE-Advanced for mobile broadband”, Elsevier, 2011
[84] J. Syren, “Overview on the 3GPP long term evolution physical layer”, Freescale White Paper, July 2007
[85] M. Baker, “LTE-Advanced physical layer”, Alcatel-Lucent, December 2009
[86] J. Xu, “LTE-Advanced signal generation and measurements using SystemVue”, Agilent Technologies
[87] X. Hou and H. Kayama, “Demodulation reference signal design and channel estimation for LTE-Advanced uplink”, DOCOMO, Adv. in Vehic. Netw. Tech., April 2011
[88] D. C. Chu, “Polyphase codes with good periodic correlation properties”, IEEE Trans. Info. [sP] Theory, vol. 18, n. 4, pp. 531-532, July 1972
[89] A. Lozano, R. W. Heath and J. Andrews, “Fundamental limits of cooperation”, March 2012, http://arxiv.org/pdf/1204.0011.pdf
[90] J. G. Andrews, “Seven ways that HetNet are a cellular paradigm shift” http://users.ece.utexas.edu/˜jandrews/pubs/And_HetNet_CommMag2012_v3.pdf
[91] J-C. Guey, and L. D. Larsson, “Nodeling and evaluation of MIMO systems exploiting channel reciprocity in TDD mode”, 2004
[92] N. Tyler, B. Allen, and H. Aghvami, “Adaptive antennas: the calibration problem”, IEEE Comm. Mag., pp. 114-122, December 2004
[93] A. Bourdoux, B. Come, and N. Khaled, “Non-reciprocal transceivers in OFDM/SDMA systems: impact and mitigation”, IEEE, pp. 183-186, 2003
[94] M. Guillaud, D. T. M. Slock, and R. Knopp, “A practical method for wireless channel reciprocity exploitation through relative calibration”, IEEE Proc. Of Sign Proc., pp. 403-406, vol. 1, August 2005
[95] P. Zetterberg, “Experimental investigation of TDD reciprocity based zero-forcing transmit precoding”, EURASIP, June 2010
[96] P. Uthansakul, K. Attakitmongkol, N. Promsuvana, and Uthansakul, “MIMO antenna selection using CSI from reciprocal channel”, Int. Journ. Of Elect. And Info. Eng., 2010

The invention claimed is:

1. A method comprising:
(1) receiving a plurality of uplink (UL) transmissions in frequency selective channels by a second plurality of antennas that is a subset or all of a first plurality of antennas of a wireless transceiver station from a third plurality of antennas of a plurality of user equipment devices (UEs), where the first plurality of antennas includes more than 8 antennas;
(2) determining a plurality of UL channel state information (CSI) in response to each UL transmission sent by one antenna of the third plurality of antennas and received by one antenna of the second plurality of antennas;
(3) deriving a plurality of downlink (DL) CSI from the plurality of UL CSI;
(4) precoding a plurality of orthogonal frequency-division multiplexing (OFDM) radio signals using the plurality of DL CSI and a plurality of radio frequency (RF) calibrations for the second plurality of antennas; and
(5) transmitting the plurality of OFDM radio signals from the second plurality of antennas to create a plurality of concurrent, non-interfering channels each at a respective location of each antenna of the third plurality of antennas.

2. The method of claim 1, further comprising the step of:
deriving the plurality of DL CSI from the plurality of UL CSI using one or more of the plurality of RF calibrations and based on UL/DL channel reciprocity.

3. The method of claim 1, further comprising the step of:
using the plurality of UL CSI to remove inter-channel interference from a plurality of UL transmissions received by the second plurality of antennas from the third plurality of antennas.

4. The method of claim 1, wherein the wireless transceiver station is within a radio access network (RAN).

5. The method of claim 1, wherein each antenna in the first plurality of antennas is operatively connected to hard-wired logic.

6. The method of claim 1, wherein each antenna in the first plurality of antennas is operatively connected to a processor operatively connected to memory.

7. The method of claim 1, wherein each antenna in the first plurality of antennas is operatively connected to hard-wired logic and to a processor operatively connected to memory.

8. The method of claim 1, wherein each antenna in the first plurality of antennas is operatively connected to hard-wired logic and the hard-wired logic is also operatively connected to a fourth plurality of antennas of another wireless transceiver station in a radio access network (RAN).

9. A method comprising:
(1) receiving a plurality of uplink (UL) transmissions in a same time slot in frequency selective channels by a second plurality of antennas that is a subset or all of a first plurality of antennas of a wireless transceiver station from a third plurality of antennas of a plurality of user equipment devices (UEs), where the first plurality of antennas includes more than 8 antennas;
(2) determining a plurality of UL channel state information (CSI) in response to each UL transmission sent by one antenna of the third plurality of antennas and received by one antenna of the second plurality of antennas;
(3) deriving a plurality of downlink (DL) CSI from the plurality of UL CSI;
(4) precoding a plurality of orthogonal frequency-division multiplexing (OFDM) radio signals using the plurality of DL CSI and a plurality of radio frequency (RF) calibrations for the second plurality of antennas; and
(5) transmitting the plurality of OFDM radio signals from the second plurality of antennas to create a plurality of concurrent, non-interfering channels each at a respective location of each antenna of the third plurality of antennas.

10. The method of claim 9, further comprising the step of:
deriving the plurality of DL CSI from the plurality of UL CSI using one or more of the plurality of RF calibrations and based on UL/DL channel reciprocity.

11. The method of claim 9, further comprising the step of:
using the plurality of UL CSI to remove inter-channel interference from a plurality of UL transmissions received by the second plurality of antennas from the third plurality of antennas.

12. The method of claim 9, wherein the wireless transceiver station is within a radio access network (RAN).

13. The method of claim 9, wherein each antenna in the first plurality of antennas is operatively connected to hard-wired logic.

14. The method of claim 9, wherein each antenna in the first plurality of antennas is operatively connected to a processor operatively connected to memory.

15. The method of claim 9, wherein each antenna in the first plurality of antennas is operatively connected to hard-wired logic and to a processor operatively connected to memory.

16. The method of claim 9, wherein each antenna in the first plurality of antennas is operatively connected to hard-wired logic and the hard-wired logic is also operatively connected to a fourth plurality of antennas of another wireless transceiver station in a radio access network (RAN).

17. A method comprising:
1) receiving a plurality of uplink (UL) transmissions in different time slots in frequency selective channels by a second plurality of antennas that is a subset or all of a first plurality of antennas of a wireless transceiver station from a third plurality of antennas of a plurality of user equipment devices (UEs), where the first plurality of antennas includes more than 8 antennas;
(2) determining a plurality of UL channel state information (CSI) in response to each UL transmission sent by one antenna of the third plurality of antennas and received by one antenna of the second plurality of antennas;
(3) deriving a plurality of downlink (DL) CSI from the plurality of UL CSI;
(4) precoding a plurality of orthogonal frequency-division multiplexing (OFDM) radio signals using the plurality of DL CSI and a plurality of radio frequency (RF) calibrations for the second plurality of antennas; and
(5) transmitting the plurality of OFDM radio signals from the second plurality of antennas to create a plurality of concurrent, non-interfering channels each at a respective location of each antenna of the third plurality of antennas;
wherein steps (1) through (5) are completed within channel coherence times of the plurality of DL CSI.

18. The method of claim 17, further comprising the step of:
deriving the plurality of DL CSI from the plurality of UL CSI using one or more of the plurality of RF calibrations and based on UL/DL channel reciprocity.

19. The method of claim 17, further comprising the step of:
using the plurality of UL CSI to remove inter-channel interference from a plurality of UL transmissions received by the second plurality of antennas from the third plurality of antennas.

20. The method of claim 17, wherein the wireless transceiver station is within a radio access network (RAN).

21. The method of claim 17, wherein each antenna in the first plurality of antennas is operatively connected to hard-wired logic.

22. The method of claim 17, wherein each antenna in the first plurality of antennas is operatively connected to a processor operatively connected to memory.

23. The method of claim 17, wherein each antenna in the first plurality of antennas is operatively connected to hard-wired logic and to a processor operatively connected to memory.

24. A method comprising:
1) receiving a plurality of uplink (UL) transmissions in same and different time slots in frequency selective channels by a second plurality of antennas that is a subset or all of a first plurality of antennas of a wireless transceiver station from a third plurality of antennas of a plurality of user equipment devices (UEs), where the first plurality of antennas includes more than 8 antennas;
(2) determining a plurality of UL channel state information (CSI) in response to each UL transmission sent by one antenna of the third plurality of antennas and received by one antenna of the second plurality of antennas;
(3) deriving a plurality of downlink (DL) CSI from the plurality of UL CSI;
(4) precoding a plurality of orthogonal frequency-division multiplexing (OFDM) radio signals using the plurality of DL CSI and a plurality of radio frequency (RF) calibrations for the second plurality of antennas; and
(5) transmitting the plurality of OFDM radio signals from the second plurality of antennas to create a plurality of concurrent, non-interfering channels each at a respective location of each antenna of the third plurality of antennas;
wherein steps (1) through (5) are completed within channel coherence times of the plurality of DL CSI.

25. The method of claim 24, further comprising the step of:
deriving the plurality of DL CSI from the plurality of UL CSI using one or more of the plurality of RF calibrations and based on UL/DL channel reciprocity.

26. The method of claim 24, further comprising the step of:
using the plurality of UL CSI to remove inter-channel interference from a plurality of UL transmissions received by the second plurality of antennas from the third plurality of antennas.

27. The method of claim 24, wherein the wireless transceiver station is within a radio access network (RAN).

28. The method of claim 24, wherein each antenna in the first plurality of antennas is operatively connected to hard-wired logic.

29. The method of claim 24, wherein each antenna in the first plurality of antennas is operatively connected to a processor operatively connected to memory.

30. The method of claim 24, wherein each antenna in the first plurality of antennas is operatively connected to hard-wired logic and to a processor operatively connected to memory.
